(19) United States
(12) Patent Application Publication
(10) Pub. No.: US 2015/0345724 A1
(43) Pub. Date: Dec. 3, 2015

(54) COMPOSITE LIGHT SOURCE SYSTEMS AND METHODS

(71) Applicant: ABL IP Holding LLC, Conyers, GA (US)

(72) Inventors: KEVIN F. LEADFORD, Evergreen, CO (US); Carl T. Gould, Golden, CO (US); Christopher J. Sorensen, Denver, CO (US); Christopher D. Slaughter, Denver, CO (US); Peter K. Nelson, Denver, CO (US); Joshua Miller, Highlands Ranch, CO (US)

(73) Assignee: ABL IP Holding LLC, Conyers, GA (US)

(21) Appl. No.: 14/807,398

(22) Filed: Jul. 23, 2015

Related U.S. Application Data
(63) Continuation-in-part of application No. 14/677,618, filed on Apr. 2, 2015.
Application No. 14/677,618 is a continuation of application No. 61/974,342, filed on Apr. 2, 2014.

(51) Int. Cl. F21S 8/00; F21K 99/00; F21V 23/00

(52) U.S. Cl. CPC F21S 8/03; F21V 23/003; F21K 9/30; F21Y 2105/001

(57) ABSTRACT

A composite light source includes at least eight illumination panels in a layout. Each of the illumination panels in the layout is adjacent at least one other of the illumination panels. All of the illumination panels emit light of the same chromaticity as one another. Each illumination panel emits light characterized by one of at least first, second, and third discrete levels of luminous intensity. At least one of the illumination panels emits light at the first level of luminous intensity; at least one of the illumination panels emits light at the second level of luminous intensity; and at least one of the illumination panels emits light at the third level of luminous intensity.

### CROSS-REFERENCE TO RELATED APPLICATIONS

This application is a continuation-in-part application of U.S. patent application Ser. No. 14/677,618, filed on Apr. 2, 2015, which claims priority to U.S. Provisional Application No. 61/974,342, filed on Apr. 2, 2014. Both of the above-identified patent applications are incorporated by reference herein, in their entireties.

### BACKGROUND

Luminaires for interior lighting are often designed for aesthetic appeal of the equipment when it is directly viewed, as well as for providing high quality illumination. Related design objectives generally include providing visually interesting components such as a housing and/or other structural components or light scattering or diffusing type elements. Examples of visually interesting components include wall- or ceiling-mounted fixtures, ornamental bases or stands of lamps, faceted glass, crystals, lampshades, and diffusers. Typically, the actual light-emitting devices within luminaires are more or less exempt from such design objectives, because users of the lighting generally will not be looking directly into the light-emitting devices, either due to discomfort, or because the light-emitting devices project light through shades or diffusers, or onto nearby surfaces to provide indirect lighting.

### SUMMARY

Composite light sources and systems of such sources herein project light that is generally “white” (but could be of another target color) on distant surfaces. The light sources themselves may include regions that are of different luminous intensities, yet may be controlled to provide uniform area lighting and/or to avoid presenting distracting patterns to viewers.

In an embodiment, a composite light source includes a plurality of at least eight illumination panels provided in a layout within the composite light source. Each of the illumination panels in the layout is adjacent at least one other of the plurality of illumination panels. All of the illumination panels emit light of substantially the same chromaticity as one another. Each illumination panel emits light characterized by one of at least first, second, and third discrete levels of luminous intensity. At least one of the illumination panels emits light at the first level of luminous intensity; at least one of the illumination panels emits light at the second level of luminous intensity; and at least one of the illumination panels emits light at the third level of luminous intensity.

In an embodiment, a composite lighting system includes a plurality of luminaires, each of the luminaires comprising at least three illumination panels provided in a layout. Across all luminaires of the composite lighting system, all of the illumination panels emit light of substantially the same chromaticity as one another, and each illumination panel emits light characterized by one of at least first, second, and third discrete levels of luminous intensity. At least one of the illumination panels emits light at the first level of luminous intensity; at least one of the illumination panels emits light at the second level of luminous intensity; and at least one of the illumination panels emits light at the third level of luminous intensity. Each of the luminaires has an identical layout of the illumination panels as each other luminaire of the plurality of luminaires, and provides a same net lumen output as is provided by each other luminaire of the luminaires.

In an embodiment, a composite lighting system includes a plurality of luminaires, each of the luminaires comprising at least three illumination panels provided in a layout. At least one of the luminaires of the composite lighting system has a layout that differs from a layout of at least one other of the luminaires of the composite lighting system. Each of the plurality of luminaires provides a same net lumen output per unit area of the layout, as is provided by each other luminaire of the plurality of luminaires. Across all luminaires of the composite lighting system, all of the illumination panels emit light of substantially the same chromaticity as one another, and each illumination panel emits light characterized by one of at least first, second, and third discrete levels of luminous intensity. At least one of the illumination panels emits light at the first level of luminous intensity; at least one of the illumination panels emits light at the second level of luminous intensity; and at least one of the illumination panels emits light at the third level of luminous intensity.

In an embodiment, a method of controlling a composite light source includes controlling illumination panels of the composite light source such that at least two of the illumination panels emit light of different luminous intensity. The method also includes controlling the illumination panels of the composite light source such that the luminous intensities of the light emitted by the at least two of the illumination panels change over time, while a combined luminous intensity of the illumination panels remains about constant.

In an embodiment, a composite light source includes a plurality of illumination panels, each of the illumination panels emitting light of a fixed color and a variable luminous intensity, wherein over time, the luminous intensities of at least two of the illumination panels vary, while a combined luminous intensity of the illumination panels remains about constant.

In an embodiment, a composite light source includes a plurality of illumination panels that emit light. Each illumination panel of at least a first subset of the plurality of illumination panels emits the light with a first luminous intensity, and each illumination panel of at least a second subset of the plurality of illumination panels emits the light with a second luminous intensity that is different from the first luminous intensity.

In an embodiment, a composite light source includes a plurality of illumination panels that emit light characterized by a luminous intensity. The light emitted by the plurality of illumination panels combines to form a far field photometric distribution characterized by a luminous intensity at each given angle from the composite light source. The luminous intensities of the light emitted by the plurality of illumination panels are controlled such that the luminous intensities of the light emitted by at least some of the plurality of illumination panels change over time, and the luminous intensity changes of the light emitted by the at least some of the plurality of illumination panels are complementary, such that the far field photometric distribution is characterized by the luminous intensity at each given angle from the composite light source remaining about constant over time.

In an embodiment, a composite light source includes light emitting means, and means for forming light emitted by the light emitting means into regions of the composite light source. At a first time, the composite light source utilizes the means for forming light to form the light from a plurality of first luminous regions. Each of the first luminous regions is discernible to a viewer as having a first spatial distribution on the composite light source, a first color and a first luminous intensity at the first time, and a far field distribution of the composite light source is characterized by a target color and a luminous intensity distribution at each given angle from the composite light source at the first time. At a second time, the composite light source utilizes the means for forming light to form the light from a plurality of second luminous regions. Each of the second luminous regions is discernible to a viewer as having a second spatial distribution on the composite light source, a second color and a second luminous intensity at the second time. A far field distribution of the composite light source is characterized by a target color and a luminous intensity distribution at each given angle from the composite light source at the second time. At least one of the target color and the luminous intensity distribution at each given angle from the composite light source do not change from the first time to the second time.

### BRIEF DESCRIPTION OF THE DRAWINGS

Embodiments are described in detail below with reference to the following figures, in which like numerals within the drawings and mentioned herein represent substantially identical structural elements.

FIG. 1 is a schematic perspective view of a composite lighting system illuminating an interior space, according to an embodiment.

FIG. 2A schematically illustrates the concepts of “white” and “complementary colors” in accord with embodiments herein.

FIG. 2B schematically illustrates the related concepts of “brightness” and “luminance” in accord with embodiments herein.

FIGS. 3A and 3B illustrate a minimum resolvable feature from the perspective of a viewer of a luminaire, and features that are less than the minimum resolvable.

FIG. 4A schematically illustrates components of a composite light source, in accord with an embodiment.

FIG. 4B schematically illustrates light emitters in a portion of the composite light source of FIG. 4A.

FIG. 5A schematically illustrates components of a composite light source, in accord with an embodiment.

FIG. 5B schematically illustrates components of a composite light source, in accord with an embodiment.

FIG. 6 schematically illustrates components of a composite light source, in accord with an embodiment.

FIGS. 7A, 7B and 7C illustrate composite light sources that have illumination panels arranged thereon, in accord with embodiments.

FIG. 8 illustrates a composite light source, in accord with an embodiment.

FIGS. 9A and 9B illustrate luminaires that each have multiple illumination panels, but which have luminaire-level controllers only, with differing levels of control sophistication, in accord with embodiments.

FIG. 10 schematically illustrates a composite lighting system, in accord with an embodiment.

FIG. 11 schematically illustrates a composite lighting system, in accord with an embodiment.

FIG. 12 schematically illustrates a composite lighting system that includes a set of luminaires, in accord with an embodiment.

FIG. 13 schematically illustrates a composite lighting system that includes a set of luminaires, in accord with an embodiment.

FIG. 14 schematically illustrates a composite lighting system that includes a set of luminaires of a first type, and two luminaires of a second type, in accord with an embodiment.

FIG. 15 is a schematic cross-sectional diagram illustrating features of a composite light source, in accord with an embodiment.

FIG. 16 is a schematic cross-sectional diagram illustrating features of a composite light source that provides an output lens and divider assembly, in accord with an embodiment.

FIGS. 17A and 17B are schematic cutaway diagrams illustrating manufacturing related features of a composite light source that provides output lenses and baffles or dividers, in accord with embodiments.

FIGS. 18A and 18B are schematic cutaway diagrams illustrating manufacturing related features of a composite light source that provides output lenses and baffles or dividers, in accord with embodiments.

FIGS. 19A, 19B and 19C are schematic cutaway diagrams, each illustrating manufacturing related features of a portion of a composite light source that provides output lenses and isolating structure, such as baffles and/or dividers, in accord with embodiments.

### DETAILED DESCRIPTION

The subject matter of embodiments of the present invention is described here with specificity to meet statutory requirements, but this description is not intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described. Each example is provided by way of explanation, and not as a limitation. For instance, features illustrated or described as part of one embodiment may be used on another embodiment to yield a further embodiment. Thus, it is intended that this disclosure includes modifications and variations.

Composite light source systems and methods are disclosed according to various embodiments. Certain embodiments provide luminous regions or illumination panels that present a “static grayscale” appearance, that is, a direct view of the regions or illumination panels will show lighting that is basically of one color, usually white, but with differing levels of brightness, or luminous intensity, among the regions or panels. The differing levels of brightness may be pre-configured or may be adjustable by a user, either explicitly or by use of controls that force a luminaire to “randomize” the luminous intensities of its panels.

Other embodiments of systems and methods generally provide lighting characterized by a far field photometric distribution of projected light that is constant (or nearly constant) in color and/or illuminance on sufficiently distant surfaces, but in a direct view, have discernible luminous regions that may vary in luminance, and potentially also in color, and/or movement. The luminous regions may be provided with luminance (and/or color) differences that are complementary to one another, such that in certain embodiments, a far field photometric distribution obtained by taking a sum of light received from each of the regions is a composite that is about constant in luminous intensity (and/or color), even though individual luminous regions may vary in luminance and/or color. In certain embodiments, luminous regions may vary in luminance, shape and/or color over time, with such variations being coordinated so that the far field photometric distribution obtained from the sum of the regions remains constant in luminous intensity and/or at color any given angle, despite the variations that can be discerned by looking directly at the regions. The light source systems themselves may also be composites of multiple illumination panels, and/or multiple light emitting elements (e.g., small or “point” light sources). Illumination panels may include planar or curved surfaces, or even three dimensional volumes, while light emitting elements may be, for example, individual light emitting diodes (LEDs) that are controlled to present an appearance of luminous regions.

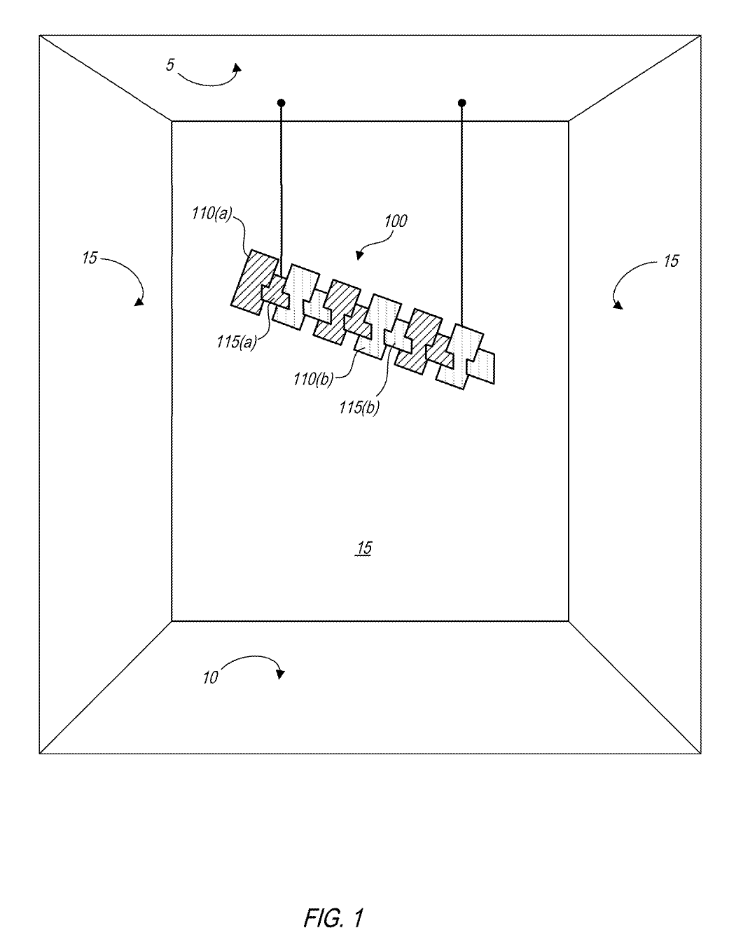

FIG. 1 is a schematic perspective view of a composite light source 100 illuminating an interior space, according to an embodiment. Light source 100 includes first illumination panels 110(a) and 110(b) and second illumination panels 115(a) and 115(b). As shown in FIG. 1, light source 100 includes three each of panels 110(a), 110(b), 115(a) and 115(b), but composite lighting systems herein are not limited to the numbers or shapes of panels shown in FIG. 1. That is, a composite lighting system may be of any shape, with the term “illumination panel” herein meaning any portion of the system that emits light characterized as being of a given color and/or luminance at a given time. Light source 100 is suspended from a ceiling 5 of the interior space such that light from light source 100 reaches ceiling 5, a floor 10 and walls 15; only three of walls 15 are shown in FIG. 1 for clarity of illustration. In light source 100, panels 115 are arranged at ninety degree angles with respect to panels 110 such that light from panels 110 and 115, collectively, emits at least a portion of light from illumination panels denoted as (a) and (b) in various directions, and an amount of light received from the (a) and the (b) panels at any given point is approximately equal.

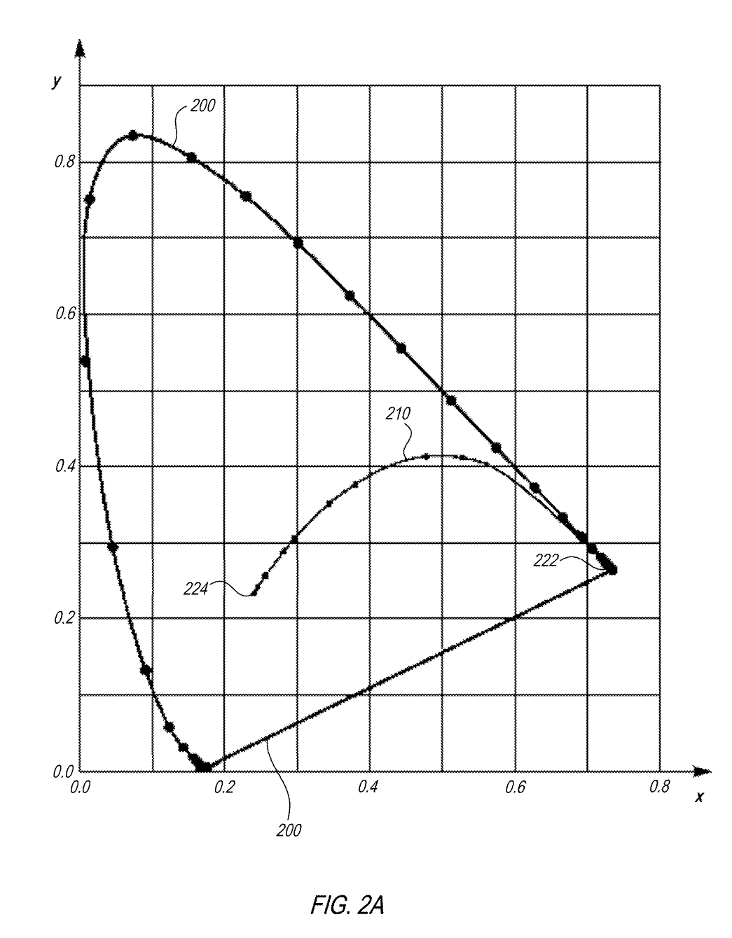

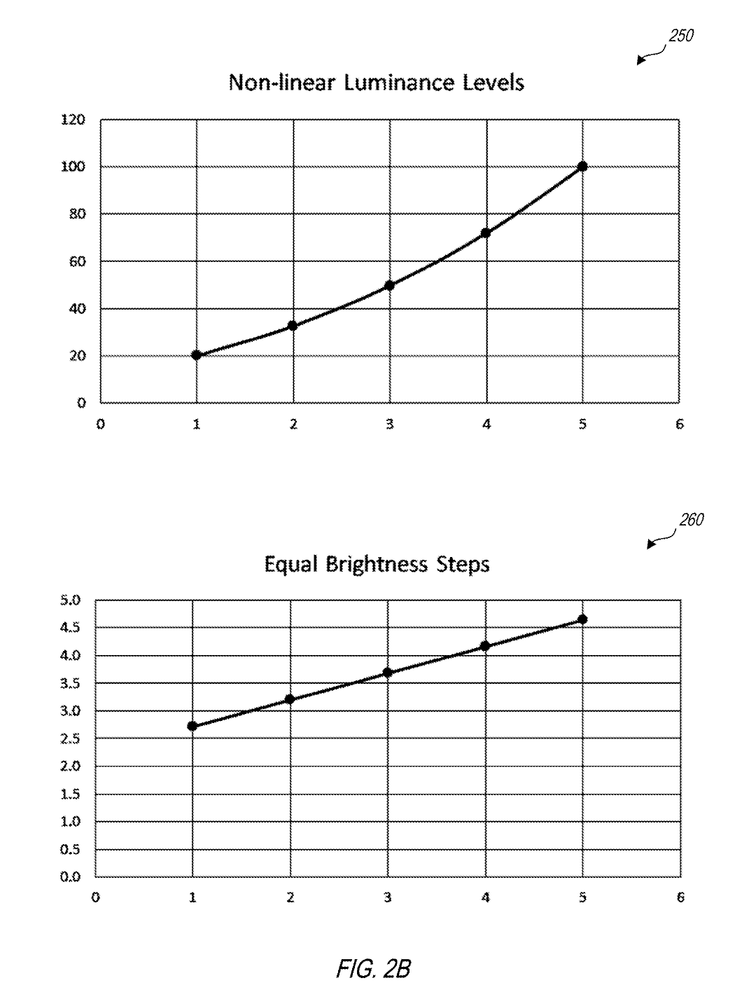

The operation of composite light source 100 is but one example of a composite lighting system, as now explained. Illumination panels 110(a) and 115(a) emit light of a first color, and illumination panels 110(b) and 115(b) emit light of a complementary second color; the first and second colors are chosen such that a sum of light projected from the illumination panels 110 and 115 yields a target color (which may be, at least approximately, “white” light, as discussed further below) at a distance from light source 100. That is, in a direct view, the individual colors of the (a) and (b) illumination panels will be visible to an observer, but the target color will be projected on surfaces illuminated by composite light source 100 and will thus provide ambient lighting for the illuminated space (e.g., in FIG. 1, ceiling 5, walls 15, floor 10 will be illuminated in the target color). For example, panels 110(a) and 115(a) may emit light that is blue, while panels 110(b) and 115(b) emit light that is yellow. At a distance, the sum of light emitted by the (a) and (b) panels in their respective complementary colors yields the target color or “white” light. The concept of using complementary pairs or higher multiples of light sources is explained further below in connection with FIG. 2A.

Furthermore, light emitted by panels 110(a), 115(a) may either be static, or may vary in color and/or luminance over time, with light emitted by panels 110(b), 115(b) varying correspondingly in color and/or luminance so that the sum of the light from all panels 110, 115 continues to yield approximately constant “white” light, or constant light of some other target color. The complementary colors emitted by panels designated as (a) and (b) above are sometimes referred to herein as forming a color set; color sets herein may include any number of colors that combine to form a target color. When a composite light source herein includes illumination panels and/or other light emitters that provide varying color and/or luminance of light over time, such variation may be controlled such that a far field photometric distribution of the light source (e.g., a measurement of the overlapping light projections of all such panels and/or light emitters on sufficiently distant surfaces) remains about constant for any given angle from the light source. Variations in ambient light of up to about +/−5% of total luminous intensity at a given angle and within a 10 step MacAdam ellipse in color are relatively insignificant to a human observer and may be considered “about constant” or “about the same” in the context of far field photometric distributions of embodiments herein. In embodiments, it may be advantageous to limit variations in ambient light to within +/−3% of total luminous intensity at a given angle and within a 5 step MacAdam ellipse in color to limit variations that may be barely visible but possibly distracting.

Further embodiments of composite lighting systems and methods are described further below in connection with FIGS. 2A-6. Such embodiments are generally characterized by a far field distribution of light that is “white” (or another target color) and is nearly constant in luminous intensity over time, but may include individual luminous regions that emit light of complementary colors and/or of varying luminance and that may vary over time. Again, “nearly constant” luminous intensity herein refers to intensity that is within +/−10%, but embodiments may limit intensity variations to within +/−5% or less. “White” or other target color may be chosen as any of several points or regions of applicable color and/or luminance within a color diagram, as discussed below in connection with FIG. 2A. The complementary colors emitted by the luminous regions are not limited to pairs of colors but may include complementary triplets or higher order multiples of colors that sum to the target color. In embodiments, luminous regions are not limited to fixed panels or other light emitters, but may be variable in form, shape, area and/or boundaries, and may overlap one another. For example, luminous regions may be formed by local variations in luminance among a plurality of light emitters that are arranged within a space or across one or more surfaces.

FIG. 2A schematically illustrates the concepts of “white” and “complementary colors” in accord with embodiments herein. Outline 200 bounds a locus of points according to the well-known CIE 1931 color space. In FIG. 2A, the horizontal x axis and the vertical y axis correspond respectively to the x, y chromaticity coordinates of a given point. Points along outline 200 correspond to completely saturated colors ranging from 400 to 700 nm, going clockwise from the bottom of the plot (around x=0.18, y=0) around to the right hand corner point (around x=0.73, y=0.26). The line connecting these two points represents a range of purple.

A line 210 within outline 200 is the Planckian locus, which corresponds to the peak wavelengths of distributions that are emitted by black bodies at temperatures ranging from low (e.g., less than 500 C) at the point labeled 222, to infinitely high, at the point labeled 224. A portion of the Planckian locus (e.g., color temperatures from around 2700K to 6500K) generally corresponds to color perceived by humans as “white.” Embodiments herein consider “white” to be any point having a chromaticity within +/−0.05 Duv from the Planckian locus, where Duv is as defined in ANSI C78.377-2008.

The following discussion relates to how pairs (or triplets, or higher order multiples) of colors may be considered “complementary” in embodiments, with reference to color definitions within the CIE 1931 color space. If a luminaire has multiple luminous regions, each producing one of multiple (at least two) luminous colors, then chromaticities of these colors can be chosen in conjunction with luminances and areas of their respective luminous regions. If chosen in this way, a net far-field output of the luminaire (the sum of the contributions of each of the luminous regions) can be effectively white light, in that it will render objects as if coming from a white light source, even though the luminaire will have a colorful direct view appearance.

To determine appropriate chromaticity for n (at least two) distinct colors of light, let xᵢ, yᵢ be the CIE chromaticity coordinates x, y of the i^{th} color out of a series of n colors. Additionally, let Yᵢ be the effective luminous content (e.g., a total flux of that color if every luminous region has the same relative far-field luminous intensity distribution, or if not, a total far-field luminous intensity of that color in a given direction) of the i^{th} color. To determine a net chromaticity of the luminaire's light output, each represented color can be converted from coordinates in the xyY color space to XYZ tristimulus values as follows:

For every I,

$$\begin{matrix}{X}_{i} = {x}_{i} \cdot \frac{{Y}_{i}}{{y}_{i}} & ( Eq . 1 ) \\ {Y}_{i} = {Y}_{i} & ( Eq . 2 ) \\ {Z}_{i} = ( 1 - {x}_{i} - {y}_{i} ) \cdot \frac{{Y}_{i}}{{y}_{i}} & ( Eq . 3 )\end{matrix}$$

From the results of Eqs. 1-3, the XYZ tristimulus values of the net luminaire output are simply respective sums of the X, Y and Z values of the n represented colors:

$$\begin{matrix}{X}_{m} = {\sum }_{i = 1}^{n} {X}_{i} & ( Eq . 4 ) \\ {Y}_{m} = {\sum }_{i = 1}^{n} {Y}_{i} & ( Eq . 5 ) \\ {Z}_{m} = {\sum }_{i = 1}^{n} {Z}_{i} & ( Eq . 6 )\end{matrix}$$

where Xₘ, Ym, Zm are the tristimulus values of net luminaire output.

Finally, net luminaire output can be converted back to xyY chromaticity coordinates via the following equations.

$$\begin{matrix}{x}_{m} = \frac{{X}_{m}}{{X}_{m} + {Y}_{m} + {Z}_{m}} & ( Eq . 7 ) \\ {y}_{m} = \frac{{Y}_{m}}{{X}_{m} + {Y}_{m} + {Z}_{m}} & ( Eq . 8 ) \\ {Y}_{m} = {Y}_{m} & ( Eq . 9 )\end{matrix}$$

Therefore, by choosing appropriate chromaticities and flux content of various luminous regions, net chromaticity and flux content of a luminaire can both be set to predefined targets. Additionally, component colors and their respective flux values can be re-configured via electronic controls, or can even be continuously dynamically adjusted while maintaining a constant net target light output in terms of both chromaticity and total luminous flux. Any set of colors, weighted by their respective flux content, that add to a target output light color are herein defined as being complementary with respect to the target color.

FIG. 2B schematically illustrates the concepts of “brightness” and “luminance” in accord with embodiments herein. The human eye/brain system is capable of detecting and processing extreme variations in light levels, and tends to interpret perceived “brightness” as about the cube root of physical “luminance,” or luminous intensity (e.g., a measurable amount of light energy). This makes it possible to provide luminaires with light intensity steps that are significantly different in luminance but are evenly and modestly different in perceived brightness.

Thus, consider a case in which five levels of luminous intensity are desired. Without loss of generality, these may be considered to represent a luminance or luminous intensity range of 20 to 100 in arbitrary units, with level 1 of brightness being equivalent to a luminous intensity of 20, and level 5 of brightness being equivalent to a luminous intensity of 100. Corresponding brightness levels can be assigned as the cube root of the arbitrary luminance numbers. The cube root of 20 is 2.714, while the cube root of 100 is 4.642:

TABLE 1
Initial assignments of exemplary Levels 1 and 5

| Level | Brightness | Luminance |
|---|---|---|
| 1 | 2.714 | 20 |
| 5 | 4.642 | 100 |

Next, the brightnesses of levels 2, 3 and 4 can be linearly interpolated to provide even brightness steps. Finally, these brightness levels can be cubed to provide the luminance levels that will provide the even brightness steps:

TABLE 2
Assignments of Levels 2, 3 and 4

| Level | Brightness | Luminance |
|---|---|---|
| 1 | 2.714 | 20 |
| 2 | 3.196 | 32.7 |
| 3 | 3.678 | 49.8 |
| 4 | 4.160 | 72.0 |
| 5 | 4.642 | 100 |

The results of these calculations are shown in Non-linear Luminance Levels plot 250, and Equal Brightness Steps plot 260, in FIG. 2B. From the above description and example, one skilled in the art will understand how to provide equal perceived brightness levels across a known luminance range, how to start with any two perceived brightness or luminance levels, calculate the corresponding luminance or brightness levels and extrapolate the two levels to further steps of brightness and luminance, and the like.

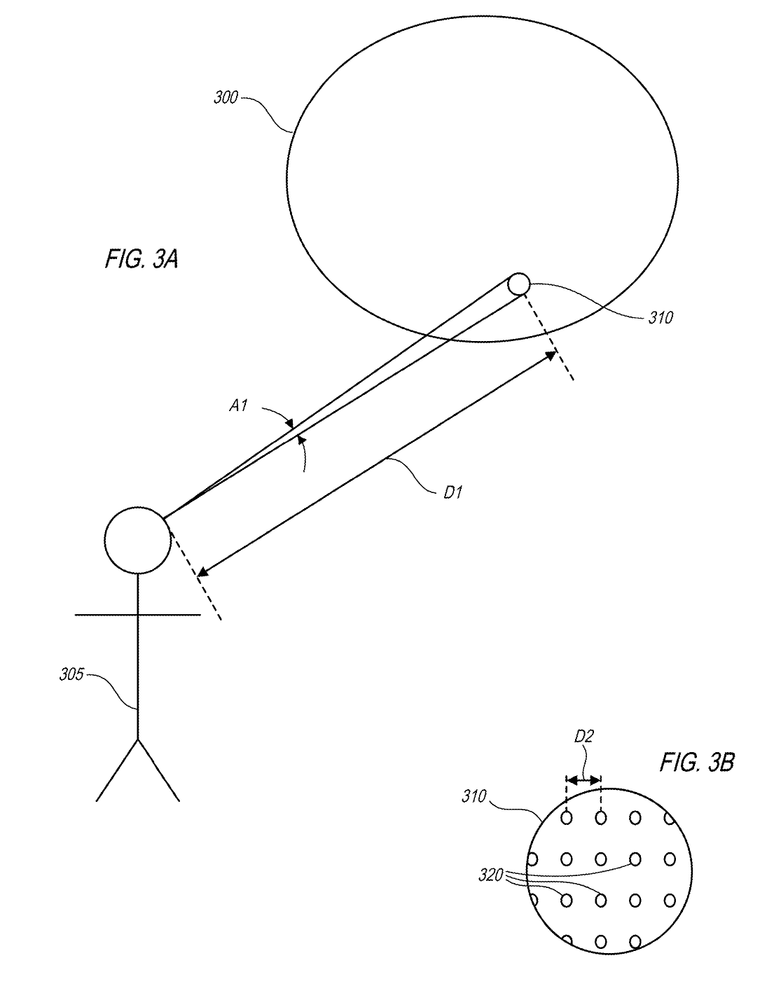

FIGS. 3A and 3B illustrate a minimum resolvable feature from the perspective of a viewer of a composite light source, and features that are less than the minimum resolvable. In embodiments, luminaires herein may include light emitters of any type, for example incandescent bulbs, fluorescent bulbs or light emitting diodes (LEDs) may be used. Light emitters may emit light of fixed wavelengths or wavelength ranges, and may be organized in either fixed or composite ways to provide luminous regions. Luminous regions are defined herein as being large enough that under typical viewing conditions they are discernible to a viewer, while light emitters that form the luminous regions may not be individually discernible. In the embodiment illustrated in FIG. 3A, a portion 310 of composite light source 300 is at distance D1 from viewer 305. When viewer 305 is at a distance D1 from portion 310 of composite light source 300, portion 310 subtends an angle of A1 within viewer 305's field of view. Portion 310 is minimally resolvable to a human with nominal visual acuity when angle A1 is about one arc minute, equivalent to a diameter of portion 310 being about 0.58 mm when distance D1 is about 2 meters. FIG. 3B provides a detailed schematic illustration of portion 310, FIG. 3A.

FIG. 3B shows light emitters 320 within portion 310 of composite light source 300. Generally speaking and not by way of limitation, the intent of composite light source embodiments herein is that at a typical viewing distance, individual light emitters may not be resolvable by a human viewer, while luminous regions are resolvable. Thus, when distance D1 in FIG. 3A is about 2 meters, light emitters 320 may not be resolvable to viewer 305 having nominal human visual acuity when a distance D2 between adjacent light emitters 320 is 0.5 mm or less. Therefore, in a first example, for typical room-scale interior light sources operating at working distances similar to about 2 meters from human viewers, embodiments herein advantageously form luminous regions that are larger in size than about 0.58 mm, while such regions may be formed from light emitters spaced apart from each other by 0.5 mm or less. In these embodiments, the luminous regions can be individually resolved by a human of nominal visual acuity, while the individual light emitters may not be resolvable. Composite light sources embodying these sizes of luminous regions and spacings of individual light emitters may be for example on the order of 15 cm to 1.5 m in size (e.g., an overall size of composite light source 300). Because embodiments herein advantageously utilize light emitters that are small in size, they can produce high light output when needed, and can provide adjustable brightness levels, light emitting diodes (LEDs), including organic LEDs (OLEDs) may be advantageously used as the light emitters.

When composite light sources are intended for larger interior spaces, larger luminous regions may be required such that human viewers of normal visual acuity may resolve the luminous regions, and larger spacing among light emitters may be utilized, considering that the viewers will generally be further away from the composite light sources. In a second example, a composite light source for a large conference room, restaurant or small ballroom may operate at a working distance similar to about 3 m from human viewers, such that the minimum size of resolvable luminous regions would scale up to about 0.9 mm and the maximum size of unresolvable emitter spacings would scale up to about 0.85 mm. A light source for this second example, having these sizes of luminous regions and spacings of individual light emitters, may be on the order of 50 cm to 5 m in size. A composite light source for a theatre or arena may operate at a working distance similar to about 18 m from human viewers, such that the minimum size of resolvable luminous regions would scale up to about 5.3 mm and the maximum size of unresolvable emitter spacings would scale up to about 5 mm. A composite light source for this second example, having these sizes of luminous regions and spacings of individual light emitters, may be on the order of 1.5 m to 12 m in size.

The concepts of luminous regions composed of light emitters at sizes that are appropriate to a given installation can also be extended to composite light sources utilizing illumination panels, e.g., composite light source 100, FIG. 1 utilizing illumination panels 110, 115. For example, various ways may be employed to spread light from a single source, or blend light from a plurality of sources, to form each illumination panel 110, 115. Using visual resolution limitations to suggest a minimum area of illumination panels 110, 115 for a composite light source 100 for a typical room-scale application yields an estimate of about 0.2 to 0.25 mm² (for circular or square panels respectively, that are spaced at the human visual acuity limit of 0.5 mm for a 2 m working distance). Aesthetically, however, to avoid an appearance that is visually “busy,” minimum panel areas may be advantageously at least 4 cm² (squares @ 2 cm/side) or even 25 cm² (squares @ 5 cm/side). For a 6 m working distance, a minimum area of illumination panels 110, 115 for a composite light source 100 may be about 9 to 11 mm² (for circular or square panels respectively, assuming a human visual acuity limit of 1.7 mm for the 6 m working distance), or to avoid a “busy” appearance, minimum panel areas may be advantageously at least 36 cm² (squares @ 6 cm/side) or even 225 cm² (squares @ 15 cm/side). For a 18 m working distance, a minimum area of illumination panels 110, 115 for a composite light source 100 may be about 20 to 25 mm² (for circular or square panels respectively, assuming a human visual acuity limit of 5 mm for the sixty foot working distance), or to avoid a “busy” appearance, minimum panel areas may be advantageously at least 400 cm² (squares @ 20 cm/side) or even 1600 cm² (squares @ 40 cm/side).

In addition to light emitters being disposed in direct view of viewers, light emitters may be disposed behind a diffuser, a refractive element, or one or more similar optical elements. These optical elements may have the effect of increasing the distance between adjacent light emitters that is resolvable by the viewers. They also can, in embodiments, diffuse and/or refract differently in one direction than another, such that individual light emitters may become indistinguishable from one another at different distances from one another depending on a direction in which the light emitters are disposed adjacent to one another.

When a luminaire has an effective aperture with spatially uniform luminance, then its far-field luminous intensity in a given direction (e.g., its far field photometric distribution) can be defined as a mathematical product of luminance and projected area of the aperture in that direction. As a function of spherical coordinates θ (vertical angle) and φ (azimuthal angle), a far-field luminous intensity distribution of a luminaire can be represented by the following equation:

I(θ,φ)=L(θ,φ)·Aₚ(θ,φ) (Eq. 10)

where
I(θ,φ) is far field luminous intensity in direction (θ,φ)
L(θ,φ) is luminance of the aperture in direction (θ,φ)
Aₚ(θ,φ) is projected area of the aperture in direction (θ,φ)

If the luminance of an aperture is not spatially uniform, then an average luminance value may be used.

If a luminaire aperture consists of multiple regions, each with an effective aperture, of varying levels of luminance, then a net far-field luminous intensity in a given direction can be defined by a summation of each region's product of luminance and projected area in that direction:

$${I}_{net} ( θ , φ ) = {\sum }_{i = 1}^{n} {L}_{i} ( θ , φ ) \cdot {A}_{pi} ( θ , φ ) \qquad ( Eq . 11 )$$

where
Iₙₑₜ(θ,φ) is net far field luminous intensity in direction (θ,φ)
Lᵢ(θ,φ) is luminance of an i^{th} region in direction (θ,φ)
Aₚᵢ(θ,φ) is projected area of the i^{th} region in direction (θ,φ)
i is an indexing number designating the respective regions

n is the total number of regions

Again, if the luminance of each region is not spatially uniform, then the average luminance value may be used.

If effective apertures of various regions remain constant over time, then the respective luminances of the regions can be varied in a wide variety of ways while maintaining a target far-field luminous intensity distribution that is a net constant. Embodiments herein compensate for increases in the luminance of some regions with decreases in the luminance level of other regions, and vice-versa.

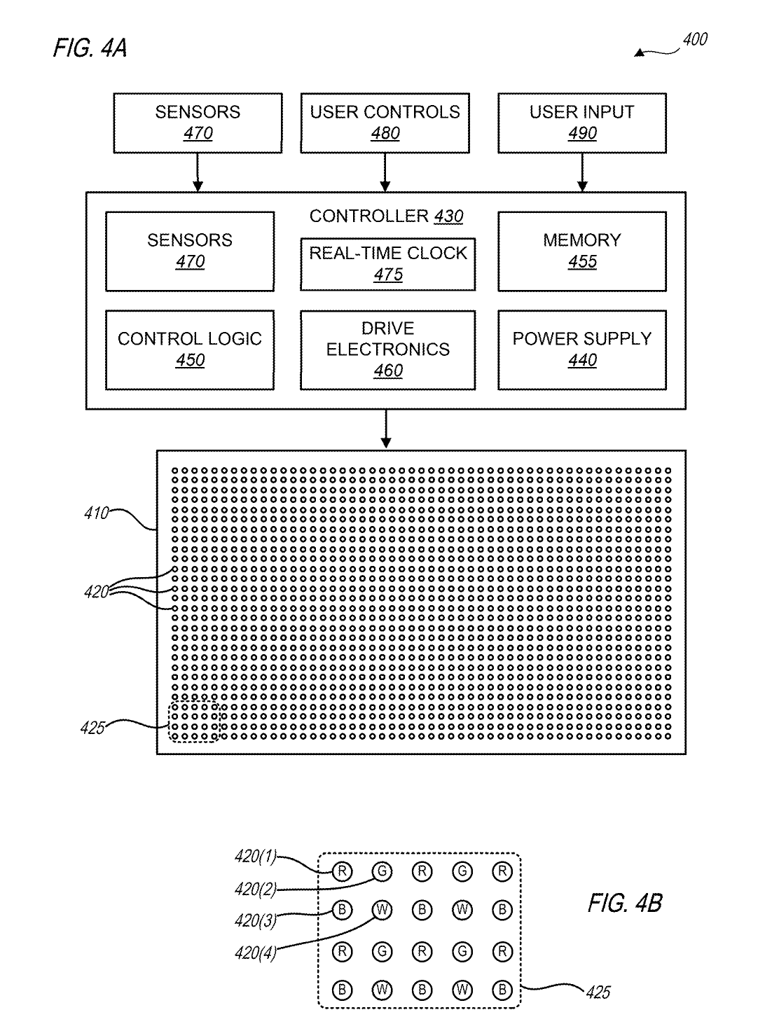

FIG. 4A schematically illustrates components of a composite light source 400, in accord with embodiments herein. Light source 400 includes a structure 410 that supports a plurality of light emitters 420; a portion 425 includes examples of light emitters 420 and is schematically illustrated in greater detail in FIG. 4B. Light source 400 also includes a controller 430 that may contain one or more of a power supply 440, control logic 450, memory 455, driver electronics 460, sensors 470 and/or a real-time clock 475. Light source 400 may also include further sensors 470, as well as user controls 480 and a user input port 490. Components of light source 400 may be, but need not be, located in a single housing; many variations are contemplated to support differing applications. For example, control logic 450 and memory 455 may be housed in one location while power supply 440 and driver electronics 460 are housed in another location (e.g., near or integrated with structure 410). Furthermore, sensors 470, user controls 480, user input port 490, and controller 430 may be structurally integrated with, or separate from, structure 410. Arrows in FIG. 4A denote flow of information and signals among components thereof; information or signals may be transferred among the components through electrical or optical connections, or wirelessly, utilizing known communication protocols.

FIG. 4B schematically illustrates light emitters 420 in portion 425 of FIG. 4A. In the example of FIG. 4B, light emitters 420(1), 420(2), 420(3) and 420(4) are red, green, blue and “white” LEDs, shown with labels R, G, B and W respectively; however other combinations of colors and/or light emitters 420 may be utilized. For example, light emitters such as multiple LED chips (e.g., red, green, blue, or other color combinations, with or without phosphors) in a single package, incandescent bulbs with filters, liquid crystal based emitters, organic LED panels (OLEDs) or other light emitters, may be utilized. Also, light emitters 420 may be of any color, although as discussed below, it may be advantageous to provide individual light emitters with colors that enable combination into luminous regions of complementary colors. LEDs are therefore an advantageous choice as light emitters 420 because of their wide availability in a variety of colors, and their tolerance for operation in both full-on and dimmed states, so that complex and/or dynamic color combinations can be formed using some LEDs operating at maximum intensity, and others that are partially dimmed. “White” light emitter 420(4) typically includes a blue semiconductor LED and a phosphor that downshifts some of the blue light emitted by the semiconductor LED into lower energy light (e.g., green, red and/or yellow) to provide a “white” appearance as judged by human viewers, but may not provide the same spectral distribution as incandescent “white” light. Embodiments herein that utilize white LEDs may treat the output of such LEDs as simply “white” or may treat it as a fixed combination of colors that is then added selectively to other colors to form luminous regions of specific colors, as described elsewhere herein. For example, embodiments different from that illustrated in FIG. 4B may not use “white” LEDs at all, but may utilize only red, green and blue or other combinations of light emitters capable of additively generating a variety of colors that are complementary to white or to another target color.

Light emitters 420 are advantageously mounted in close proximity with one another upon or within structure 410 such that individual ones of light emitters 420 are not resolvable by a human viewer at a typical viewing distance (such distance may vary according to individual applications, as discussed above with respect to FIGS. 3A, 3B). Light emitters 420 may be arranged upon a surface in rectilinear array fashion, as shown in FIGS. 4A and 4B, or may be arranged in other types of arrays, arranged in non-arrayed fashion upon a surface, or arranged (in arrayed or non-arrayed fashion) in three dimensional space.

In operation of composite light source 400, controller 430 controls light emitters 420 such that light emitters 420 form regions that are discernible to human viewers as being formed of multiple, static or changing, regions of color and/or luminance in a direct view (e.g., looking at light source 400) while a space that is illuminated by light source 400 receives a single target color at a constant illumination level. The target color is usually white or some variation thereof (e.g., various color temperatures of “white”) but can be any color. A design goal of light source 400 may be to provide ambient task lighting (therefore, usually white) while making light source 400 interesting for viewers through presentation of one or more patterns of complementary colors and/or varying luminances that add up to the target color and luminous intensity. The patterns may also change over time, to provide further viewer interest. Controller 430 controls light emitters 420 so that the complementary colors can change in position, color, or luminance level or any combination thereof, while maintaining the target color and/or luminous intensity. Thus, the space that is illuminated by light source 400 continuously receives light that is satisfactory for general task lighting, but light source 400 provides a source of viewer interest not found in plain “white” (e.g., uncolored) and/or static lighting.

To do this, control logic 450 determines, at each point in time, a combination of two or more complementary colors that, weighted by the respective luminances and areas, form the target color, and a pattern in which the two or more colors may be displayed. Patterns may be generated randomly by control logic 450, may be based on templates provided through user input port 490 and/or may be stored in memory 455. Patterns input to light source 400 through user input port 490 can, in embodiments, be rejected, flagged or modified by control logic 450 to ensure an appropriate balance of color distributions. For example, if a binary image is provided in user input port 490, control logic may review the provided image to determine the ratio of areas to be rendered in a first color and a second color, so that the resulting far field distribution remains white (or other target color). If the binary image is too heavily weighted towards one color or the other, control logic 450 can either alert the user to the improper weighting, or modify the binary image to one with a more appropriate ratio of colors. Non-limiting examples of patterns that may be generated by control logic 550 include geometric shapes such as circles, squares, triangles, other polygons, random points or blocks of any shape; combinations or swirls based on any such patterns, and text; any such patterns may change over time, and may for example form swirling patterns such as simulated waterfalls, rain, tunnels or a “star field” effect in which objects appear to move toward or past a viewer.

Having determined a combination of colors and a pattern, control logic 450 generates an intensity state to which each light emitter 420 is to be set to achieve the colors and the pattern. In embodiments, this information is utilized to provide appropriate voltage and/or current input to each light emitter 420, using power from power supply 440. For example, having determined a level of light desired from each light emitter 420, control logic 450 may direct driver electronics 460 to provide the appropriate voltage and/or current to each of the light emitters 420. Users of light source 400 can provide patterns to user input port 490 for storage in memory 455 and use by controller 430. Users of light source 400 can utilize user controls 480 to select attributes such as overall brightness, target color, complementary colors and patterns, and sequences of any of these attributes, to be provided by light source 400. Sensors 470, whether separate from or integrated with controller 430, can monitor the space that is illuminated by light source 400 (or can monitor some other space) and provide additional input to controller 430.

Controller 430 may also respond to time information from real-time clock 475 to adjust lighting provided by light emitters 420. For example, a target color projected by light emitters 420 may be adjusted to provide “white” light of a given color temperature as expected of natural daytime and/or seasonal variations. In another example, overall luminous intensity provided by light emitters changes to provide more light in early morning and/or evening hours for task lighting, but less light during the day when ambient light (e.g., sunlight) may be available in the illuminated space.

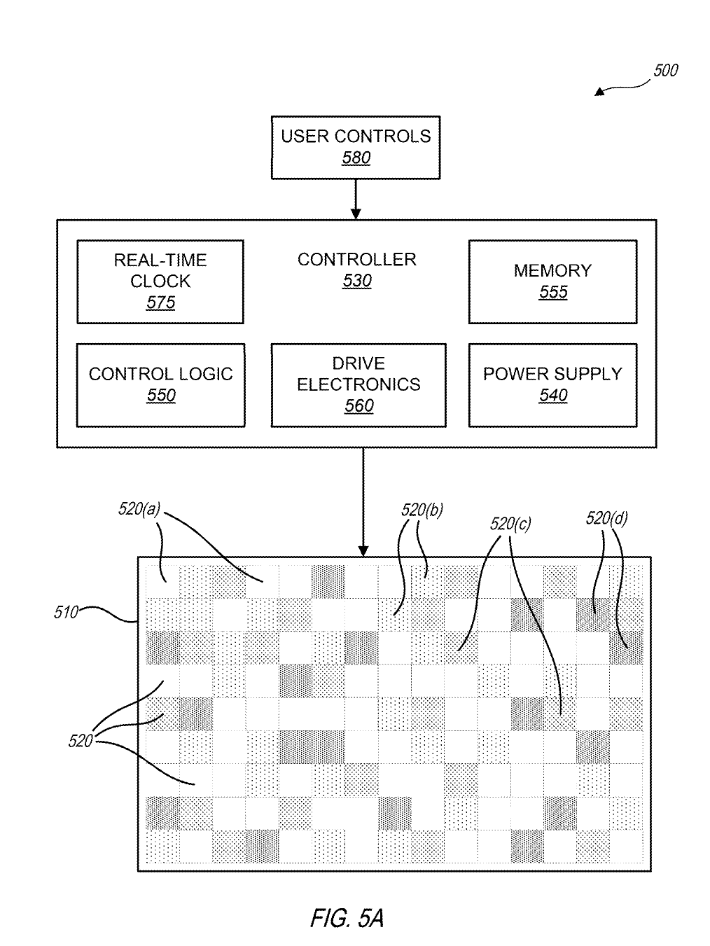

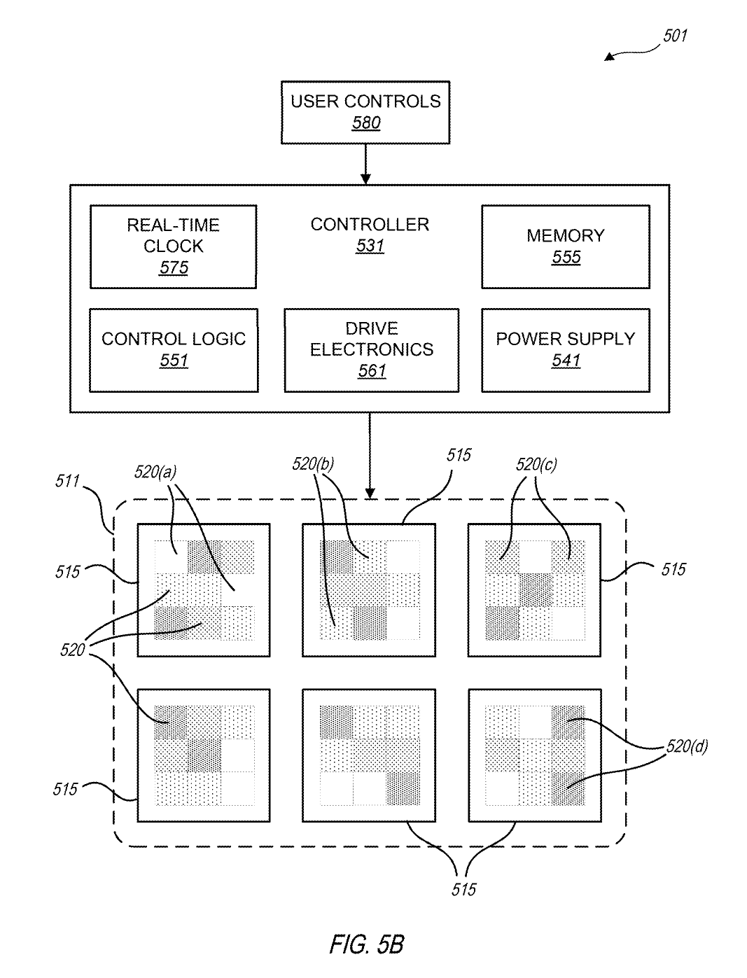

FIG. 5A schematically illustrates components of a composite light source 500, in accord with embodiments herein. Composite light source 500 includes many components similar to those found in composite light source 400. Composite light source 500 includes a structure 510 that supports a plurality of illumination panels 520; structure 510 need not be a rectilinear array as shown but could be any kind of structure, including a plurality of structures connected by wiring (see also FIG. 5B). For example, in embodiments, structure 510 may be a series of strips of illumination panels 520 configured for embedding in a ceiling. In the embodiment illustrated in FIG. 5A, illumination panels 520 of light source 500 are of a given perceived color (but other embodiments may include light emitters of more than one perceived color, or of variable colors). Particular ones of the illumination panels 520 emit light with differing characteristics from one another, such characteristics may include luminance, color or both. For example illumination panels 520(a) emit light with relatively high luminance, illumination panels 520(b) emit light with somewhat lower luminance, illumination panels 520(c) emit light with lower luminance still, and illumination panels 520(d) emit light with lower luminance still (only two instances each of illumination panels 520(a), 520(b), 520(c) or 520(d) are labeled in FIG. 5A, for clarity of illustration). Light source 500 also includes a controller 530 that may contain one or more of a power supply 540, control logic 550, memory 555, driver electronics 560, and/or a real-time clock 575. Light source 500 may also include user controls 580. Components of light source 500 may be, but need not be, located in a single housing; many variations are contemplated to support differing applications. For example, control logic 550 and memory 555 may be housed in one location while power supply 540 and driver electronics 560 are housed in another location (e.g., near or integrated with structure 510). Furthermore, user controls 580 and controller 530 may be structurally integrated with, or separate from, structure 510. Arrows in FIG. 5A denote flow of information and signals among components thereof; information or signals may be transferred among the components through electrical or optical connections, or wirelessly, utilizing known communication protocols.

Composite light source 500 illustrates an embodiment that provides projected light of a constant perceived color for ambient task lighting; such light is therefore typically “white” but could be of any target color. That is, illumination panels 520 may provide projected light that is of a single color, but is of differing luminous intensity from one illumination panel 520 to the next, or of differing colors, with the net projected light being of one target color. The relative luminous intensities and/or colors of illumination panels 520 may be static or may vary at any given point in time. User controls 580 may be as simple as on/off and/or dimmer switches, or may provide more complex information to controller 530, such as information about how to vary lighting based on time of day, day of week or season of year, or to select from various options for dynamic variations of lighting levels provided by illumination panels 520.

FIG. 5B schematically illustrates components of a composite light source 501, in accord with embodiments herein. Composite light source 501 includes many components similar to those found in composite light sources 400 and 500. Composite light source 501 includes a luminaire layout 511 having a plurality of luminaires 515, each luminaire 515 having, in turn, a plurality of illumination panels 520, as shown. Layout 511 need not be a rectilinear array as shown but could be any kind of layout of luminaires 515, in a common physical structure or as a group of physically separate luminaires 515 interfacing with a common controller 531. Similarly, the layout of each luminaire 515 with nine illumination panels 520 is exemplary only, a luminaire 515 may have any number or layout of illumination panels 520. It is noted that herein, the term “layout” refers to physical configuration of illumination panels irrespective of the luminous intensity of light emitted by the illumination panels, while “arrangement” is used to denote patterns formed by the luminous intensities of the light emitted. Arrows in FIG. 5B denote flow of information and signals among major components thereof; information or signals may be transferred among the components through electrical or optical connections, or wirelessly, utilizing known communication protocols. Connections from a controller 531 to and among the various luminaires 515 of layout 511 are not shown, for clarity of illustration, but such connections may be made by wiring and/or wirelessly. In the embodiment illustrated in FIG. 5B, illumination panels 520 of light source 501 are of a given perceived color (but other embodiments may include light emitters of more than one perceived color, or of variable colors). In light source 501, like light source 500, particular ones of the illumination panels 520 emit light with differing characteristics from one another, such characteristics may include luminance, color or both. For example, illumination panels 520(a) emit light with relatively high luminance, illumination panels 520(b) emit light with somewhat lower luminance, illumination panels 520(c) emit light with lower luminance still, and illumination panels 520(d) emit light with lower luminance still. In the embodiment shown, each luminaire 515 of layout 511 includes two illumination panels 520(a), three illumination panels 520(b), two illumination panels 520(c) and two illumination panels 520(d), with placement of illumination panels 520(a), 520(b), 520(c) and 520(d) being rearranged within each luminaire 515. Thus, each luminaire 515 will provide the same net illumination as each other luminaire 515, but the direct views of luminaires 515 will differ from one another, for an aesthetically interesting appearance.

Light source 501 also includes controller 531 that may contain one or more of a power supply 541, control logic 551, memory 555, driver electronics 561, and/or a real-time clock 575. Light source 501 may also include user controls 580. Components of light source 501 may be, but need not be, located in a single housing; many variations are contemplated to support differing applications. For example, control logic 551 and memory 555 may be housed in one location while power supply 541 and driver electronics 561 are housed in another location (e.g., near or integrated with layout 511). Furthermore, user controls 580 and controller 531 may be structurally integrated with, or separate from, layout 511.

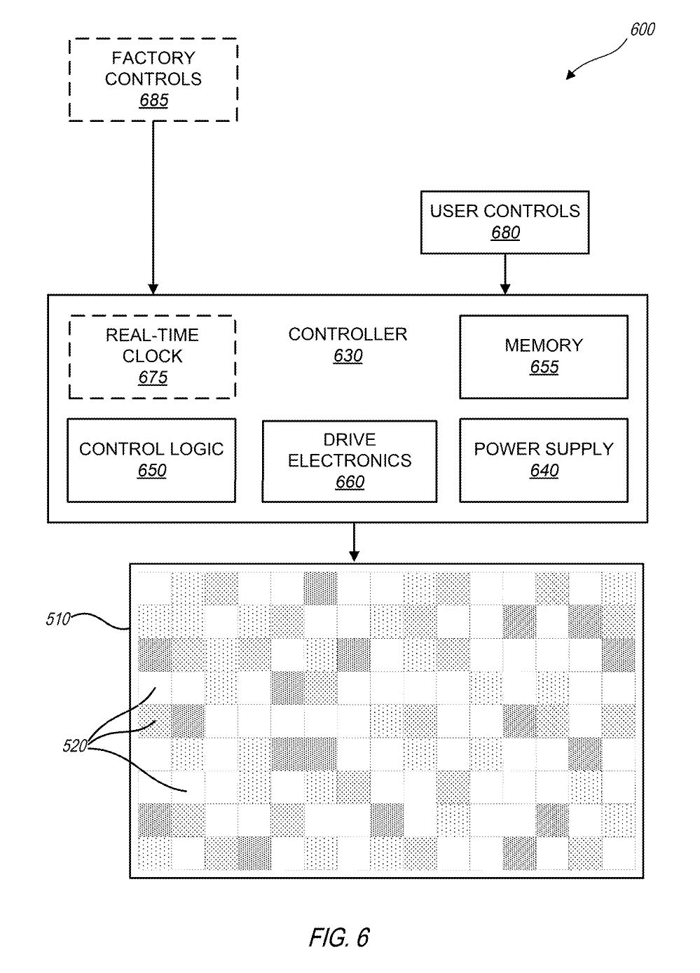

FIG. 6 schematically illustrates components of a composite light source 600, in accord with embodiments herein. Components 630, 640, 650, 655, 660 and 675 of composite light source 600 are substantially similar to similarly named components in composite light source 500, FIG. 5, and structure 510 and illumination panels 520 are identical to those shown for composite light source 500. Real-time clock 675 is an optional component in composite light source 600.

During manufacturing and/or initial installation, light source 600 is responsive to factory controls 685. Factory controls 685 may interact with controller 630 through a connector that is attached in the factory or installation site and later removed, or through known wireless and/or optical methods. In certain embodiments, a primary setup is provided by interaction of factory controls 685 with controller 630, and remains fixed (e.g., as instructions coded within memory 655) throughout operation of light source 600. In other embodiments, a primary setup provided by interaction of factory controls 685 with controller 630 controls certain aspects of operation of light source 600, while controller 630 continues to control other aspects. For example, differing luminous intensities of illumination panels 520 may be originally set through interaction of factory controls 685 with controller 630, and remain fixed thereafter, but controller 630 may continue to apply overall luminous intensity changes to illumination panels 520 (e.g., to implement time of day, day of week and/or season of year based variations in lighting). While user controls 580 are also shown as part of light source 600, user controls 580 may be as simple as on/off and/or dimmer switches.

It should be understood that composite light sources 400, 500 and 600 provide successively decreasing levels of functionality and therefore cost, as may be appropriate for specific lighting applications. Therefore it should also be understood that embodiments having feature sets that are intermediate to the features shown in composite light sources 400, 500 and 600 are also contemplated herein.

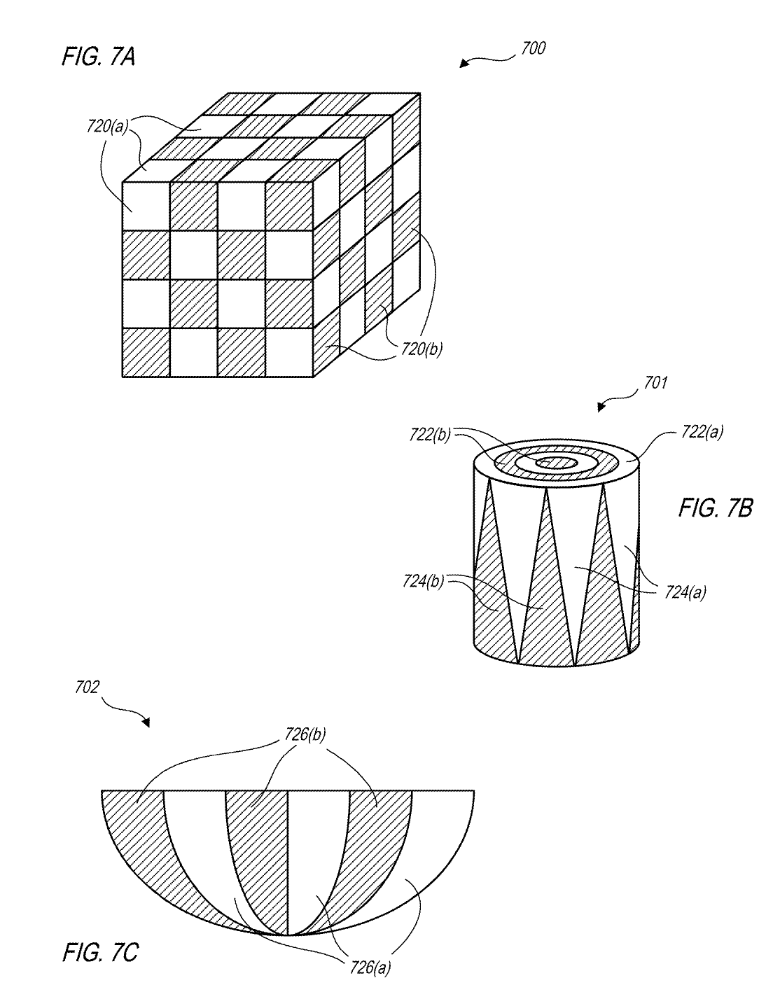

FIGS. 7A, 7B and 7C illustrate composite light sources 700, 701 and 702 respectively, that have illumination panels arranged thereon, in accord with embodiments. Composite light source 700 forms a cube shape, shown in perspective view, with square illumination panels 720(a) and 720(b) arranged thereon. Composite light source 701 forms a cylinder, shown in perspective view, having triangular illumination panels 724(a) and 724(b) on a side surface thereof and annular illumination panels 722(a) and 722(b) on a top surface thereof. Composite light source 702 forms a semisphere, shown in side elevation, having segment-shaped illumination panels 726(a) and 726(b) on a downwardly facing surface thereof. Only representative ones of illumination panels 720, 722, 724 and 726 are labeled in FIGS. 7A, 7B and 7C, for clarity of illustration. In each of composite light sources 700, 701 and 702, the illumination panels designated as (a) emit light of a first color, and the illumination panels designated as (b) emit light of a complementary color thereto, such that a far field photometric distribution thereof formed by projected light from the (a) and (b) panels is of a target color, which may be white. The (a) and (b) illumination panels may change in color and/or luminous intensity over time, with the changes arranged such that the target color and luminous intensity of the far field photometric distribution remain about constant.

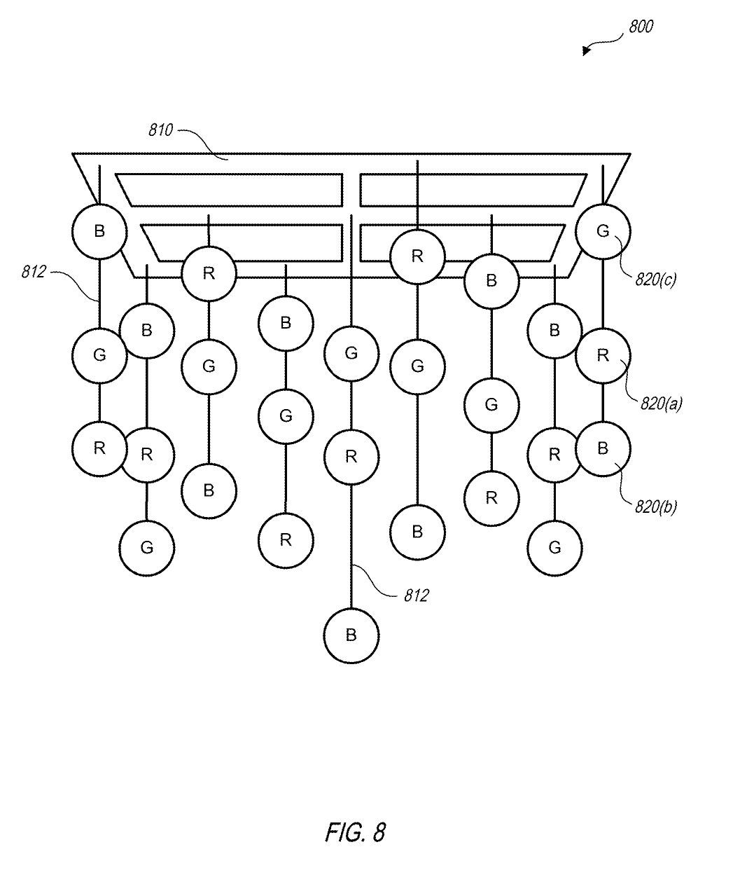

FIG. 8 illustrates a composite light source 800, in accord with an embodiment. In composite light source 800, illumination panels 820(a), 820(b) and 820(c) are suspended from a structure 810 by cables 812; only a small number of illumination panels 820(a), 820(b) and 820(c) and cables 812 are labeled in FIG. 8, for clarity of illustration; however each illumination panel 820(a) is labeled with an R, each illumination panel 820(b) is labeled with a B, and each illumination panel 820(c) is labeled with a G. Thus, composite light source 800 provides a three-dimensional structure of illumination panels 820, in a direct view. Illumination panels 820 are illustrated as spheres, but may be of any shape. Illumination panels 820(a), 820(b) and 820(c) emit light that is complementary to one another to form a far field photometric distribution of a target color. For example, the light emitted by illumination panels 820(a), 820(b) and 820(c) may be red, blue and green respectively, such that the target color is white. Illumination panels 820(a), 820(b) and 820(c) may change in color and/or luminous intensity over time, with the changes arranged such that the target color and luminous intensity of the far field photometric distribution remain about constant.

Further embodiments include, but are not limited to, the following. In one embodiment, a composite light source includes a structure having surfaces on which light emitters are mounted, and/or light emitters arranged in space (e.g., light emitters may be mounted on an open lattice type structure, supported in space by transparent support members, and/or encased in a transparent matrix, and the like). The light emitters may be of individual colors that can, by selective operation and/or mixing, additively produce “white” light as disclosed herein, or another color of light, in a far field photometric distribution. Alternatively, the light emitters may be of a single color; luminance of the light emitters may vary over time such that the net far field luminous intensity is nearly constant although the far field luminous intensity is coming from different light emitters at different times. The average color in the far field photometric distribution, whether “white” or something else, will be called the “target color” for purposes of the following discussion.

The light emitters may be positioned indistinguishably adjacent to one another in space, and controllable such that groups of the individual light emitters form visually distinct luminous regions, or the light emitters may be positioned distant to one another such that individual ones of the light emitters are discernible to a viewer. The luminous regions and/or individual ones of the light emitters may be of complementary colors such that at a distance from the light source, the colors combine to project the target color into the illuminated space. That is, the colors of the luminous regions or individual light emitters will be seen by a viewer who looks at the light source, but the composite photometric distribution of the projected light will be of the target color. The individual light emitters may be controlled such that luminous regions formed thereby change over time, but the complementary nature of the colors emitted thereby is retained such that the target color remains constant or nearly constant. Again, “nearly constant,” “about the same,” “roughly constant” and similar terms herein, in the context of color, refer to projected light having a net chromaticity that is within a ten step MacAdam ellipse in color variability, although certain embodiments may limit net chromaticity to within a five step MacAdam ellipse. The complementary colors may be in pairs, threes or some other multiple, but always sum to form the target color. The luminous regions may be fixed in location in the composite light source, or may change over time by controlling the light emitters. That is, light emitters may be controlled such that a given light emitter may appear to be part of a first luminous region at a first point in time, but the same light emitter may appear to be part of a different luminous region at a different point in time. Similarly, a composite light source may have emitters of a single target color (e.g., white) that individually vary in intensity over time, while a net projected light output of the light source remains constant.

For example, a surface of a composite light source may have light emitters that are individually addressable, and are spread over the surface. In aspects, the light emitters may be arranged and addressable as elements of a rectilinear array, a hexagonal array, a polar array, any other form of array or in a non-arrayed (e.g., random or pseudo-random) layout. The light emitters may be activated such that at a first time, light from the light emitters forms luminous regions of a first color, and regions of a second color that is complementary to the first color with respect to a target color. The luminous regions may be geometric in nature (e.g., stripes, triangles, squares, other polygons, circles, ellipses and the like), may form letters or numbers (in random order, or forming one or more text strings), may be based on a monochromatic image (e.g., a picture reduced to a two-valued image, like a “black and white” image with the “black” and “white” being the complementary colors), may be algorithmically derived, or may be random. In embodiments, a user may specify (e.g., utilizing user controls 480, FIG. 4A) a color, and a controller of the composite light source (e.g., controller 430, FIG. 4A) responds by determining a complementary color thereto, and the composite light source may display the user-specified color such that the user-specified color and the complementary color form a white projected color on nearby surfaces. In other embodiments, users may specify multiple color options, such as picking two (or more) colors, with the composite light source providing output of the complementary colors so that the users can see if a target color, formed by the colors and projected on nearby surfaces, is satisfactory. In still other embodiments, a controller of the composite light source may adjust one or both of colors intended as complementary colors such that a specified target color is formed thereby. The complementary colors may vary extremely from one another (e.g., colors from near the edges of the CIE 1931 color space) or they may vary less from one another (e.g., colors that are near to, but on opposite sides from, “white” or other target color in the color space). Small, random luminous regions that change over time may generate a “shimmer” effect that is preferable in some applications, in that identifiable and thus potentially distracting shapes or images are not generated. Algorithms for generating patterns, and system implementations of such algorithms, may include randomizers to generate effects that include such random variations, random seed patterns, random choices of text and images, and the like so as to avoid presentation of repetitive patterns to viewers.

Over time, the individual light emitters can be controlled such that the complementary colors change in hue and/or brightness so that the luminous regions appear, at a second and/or subsequent times, different in color (remaining complementary) or in shape from their appearance at the first time, or converge on the target color.

In one embodiment, the individual light emitters are all activated at a first time such that the surface uniformly presents the target color. Over a time period, individual ones of the light emitters increase in brightness while others decrease in brightness, until at a second time, visually distinct luminous regions are discernible by a viewer. The luminous regions form a first pattern, and the regions are of first complementary colors such that the far field photometric distribution remains of the target color. Over another time period, individual ones of the light emitters increase in brightness while others decrease in brightness, until at a third time the surface is again uniformly of the target color. Over another time period, individual ones of the light emitters increase in brightness while others decrease in brightness, until at a fourth time, visually distinct luminous regions are again discernible by a viewer. The luminous regions form a second pattern that is different from the first pattern, and the regions are of second complementary colors such that the far field photometric distribution remains of the target color. The second complementary colors may be the same as the first complementary colors, or they may be different. Over another time period, individual ones of the light emitters increase in brightness while others decrease in brightness, until at a fifth time the surface is again uniformly of the target color in appearance. The composite light source of this embodiment continues to oscillate between a uniform appearance of the target color, and one or more appearances characterized by luminous regions of complementary colors that continue to provide a far field photometric distribution of the target color.

Further variations are also possible; for example, individual ones of the light emitters may be manipulated to form patterns of luminous regions that shift from one pattern to another without reverting to the target color in between; different complementary color sets may be implemented at varying times, the patterns formed by the luminous regions may vary in size, shape and number. The luminous regions may have well defined boundaries, or there may be transitional areas between the regions wherein the individual light emitters are controlled so as to provide blending between the regions. Also, some of the luminous regions may remain constant while others change, care being taken to preserve the overall far field photometric distribution of the target color. Still other embodiments may provide light emitters having unchanging color, but with changing luminance, such that the far field photometric distribution is nearly constant in luminous intensity but individual source(s) of the luminous intensity fade in and out.

Embodiments herein may also be interactive, that is, effects therein may be driven in a temporal sense by external input other than time. For example, timing or type of changes in luminous regions discussed above may be driven by noise levels or specific sounds within an interior space or in the vicinity of the light source. A peaceful visual environment of no changes, slow changes, minimal color changes or “shimmer” effects as discussed above may be provided when the interior space is silent or provides low noise levels, while loud or chaotic noises may trigger a more exciting visual environment characterized by large color changes, rapid changes among colors and/or patterns, and use of certain patterns. Detection of rhythmic beats in room noise may be used to synchronize behavior of the light source to the beats. In some embodiments, motion sensors are utilized to tailor lighting to usage of an interior space, e.g., by providing more light in parts of the space where people appear to be, based on input from the sensors. Interactive responses to these and other external cues can heighten appeal to viewers.

Still other embodiments herein may provide slowly time-varying changes in the far field photometric distribution. For example, a composite light source may provide a target color, as discussed above, that slowly varies according to time of day, to simulate natural daylight changes; the target color itself may also be chosen to vary from day to day, for example varying throughout the year to mimic natural daylight variations. The range and rate of variation may be stored in memory of a composite light source (e.g., memory 455, FIG. 4A) where it can form a reference for the lighting provided on a given date and/or time. Other changes are also possible to provide a light source that provides points of visual interest for viewers, through differences in color, luminance or dynamics, within a space that is illuminated by the light source.

Certain embodiments herein do not feature a controller that controls more than one luminaire at a time, but instead have controls that affect the operation of a single luminaire only, or are preconfigured at the luminaire level. Such luminaires may be manufactured, sold and/or installed in sets, so as to provide lighting with parameters that are coordinated by design across a set of luminaires in a single installation. A plurality of such luminaires may be operated in parallel by user controls in the installation. However, after their manufacture and/or factory setup, and other than responding to user controls, illumination panels of the luminaires may not be controlled by a single, system level controller. That is, individual luminaires may have power switched on, off or to a partial (“dim”) condition, but there may not be further system level control over luminance levels emitted by specific ones of the illumination panels within the luminaires. Individual ones of the luminaires may have such control features, as now discussed.

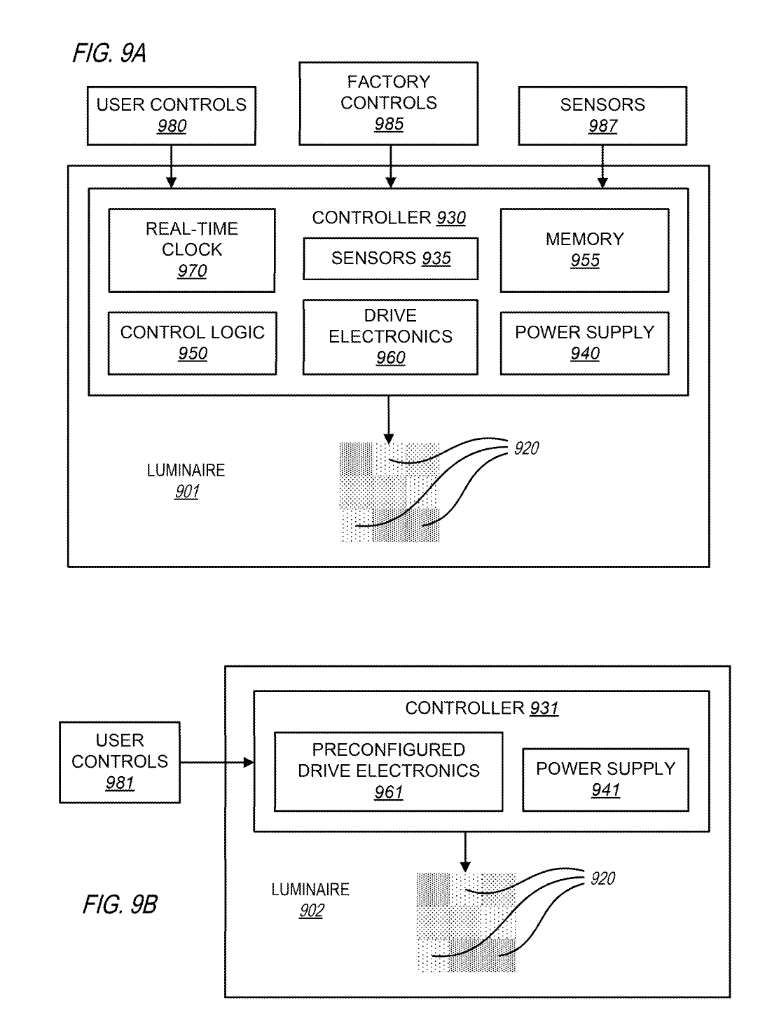

FIGS. 9A and 9B illustrate luminaires that each have multiple illumination panels 920, but which have luminaire-level controllers only, with differing levels of control sophistication. In each of luminaire 901, FIG. 9A, and luminaire 902, FIG. 9B, a 3 by 3 grid of square illumination panels 920 is shown, each illumination panel emitting one of three luminous intensity levels. It should be understood that the number, layout, arrangement, aspect ratios and luminous intensity levels are understood to be exemplary only. Embodiments herein may include any number or layout of illumination panels 920, shaped and/or arranged in any way, and emitting any number of luminous intensity levels. Many embodiments will include illumination panels that are at least rectilinear and laid out with edges of adjacent illumination panels adjoining one other. Also, as a practical matter, luminous intensity levels of multiple illumination panels are considered “about the same” herein, if average luminous intensity levels per unit area of the illumination panels match one another to within about 5%.

Luminaire 901, FIG. 9A, includes illumination panels 920 and a controller 930 with features such as sensors 935, a real-time clock 970, control logic 950 and memory 955, all of which can be used like the similarly named features shown in FIGS. 4A, 5A, 5B and 6. Controller 930 also includes a power supply 940, and driver electronics 960 that are responsive to control logic 950. Initial setup of luminaire 901 may include receiving and storing settings included in factory controls 985. Luminaire 901 may be responsive to input received from external sensors 987 and/or operated via user controls 980. User controls 980 may include simple controls such as on/off and dimming, but in luminaire 901, control logic 950 and/or programs stored in memory 955 may also be responsive to certain types of input supplied through user controls 980. In particular, control logic 950 may be responsive to user controls 980 to allow a user to provide input to luminaire 901 to change a net color emitted by illumination panels 920 as a group, randomize a pattern of luminous intensity levels in illumination panels 920, apply a certain program that is stored in memory 955, and the like. A capability for randomizing luminous intensity levels may be particularly advantageous in order to equalize wearout mechanisms across light emitters of illumination panels 920, and their associated driver electronics 960. If varying degrees of luminous intensity are provided without randomizing, certain light emitters in illumination panels 920, and/or their associated driver electronics 960 may be consistently driven the hardest and thus may wear out long before others. Randomization could occur every time luminaire 901 is powered up, periodically upon expiration of a time limit for a given configuration, and the like. Luminaire 901 thus represents a high level of control sophistication, but only controls illumination panels 920 of luminaire 901, and does not control illumination panels of other luminaires.

Luminaire 902, FIG. 9B, includes the same illumination panels 920 as luminaire 901, but controller 931 of luminaire 902 includes only a power supply 941 and preconfigured driver electronics 961. Luminaire 902 may be operated by user controls 981, but only in the sense that user controls 981 switch power to luminaire 902 on or off, or to control a fraction of power available to luminaire 902 to provide dimming. Preconfigured driver electronics 961 can implement a pattern of luminous intensity variations across illumination panels 920, but output drivers 961 do not respond to user controls 981, other than allowing a user to turn luminaire 902 on or off, or to brighten or dim all illumination panels 920 in concert with one another. Preconfigured driver electronics 961 may be implemented as hardware (e.g., circuitry that explicitly provides specific voltage or current levels to each of the illumination panels 920) or as firmware (e.g., as a set of drivers that are controlled by settings embedded in non-volatile memory). Luminaire 902 thus represents a low level of control sophistication, and only controls illumination panels 920 of luminaire 902.

Luminaires 901 and/or 902 can be provided and/or installed in sets to provide a composite lighting system that has multiple luminaires, where each luminaire provides light of a particular chromaticity, and both individual ones of the luminaires and the installation as a whole have light intensity patterns that are interesting but not distracting. Luminaires 901 provide a high degree of explicit user control over the distributions of luminous intensity across the associated illumination panels 920 of each luminaire, while distributions of luminous intensity across illumination panels 920 of luminaires 902 can be preset (through configuration of preconfigured driver electronics 961) but cannot be altered thereafter. Either or both of luminaires 901 and 902 can be factory-configured such that each luminaire in a set provides a same net lumen output as is provided by each other luminaire of the set. Herein, references to “the same,” “substantially constant,” “similar” and the like in reference to net lumen output are understood to mean net lumen output that is the same at least within a 10% tolerance, and in many embodiments, within a 5% tolerance. Although FIG. 9A illustrates luminaire 901 with many more control features than luminaire 902, FIG. 9B, intermediate luminaires with more control features than luminaire 902, but not necessarily all of the features of luminaire 901, are contemplated. That is, any luminaire that includes any of the features of luminaire 901 is considered within the scope of the present disclosure.

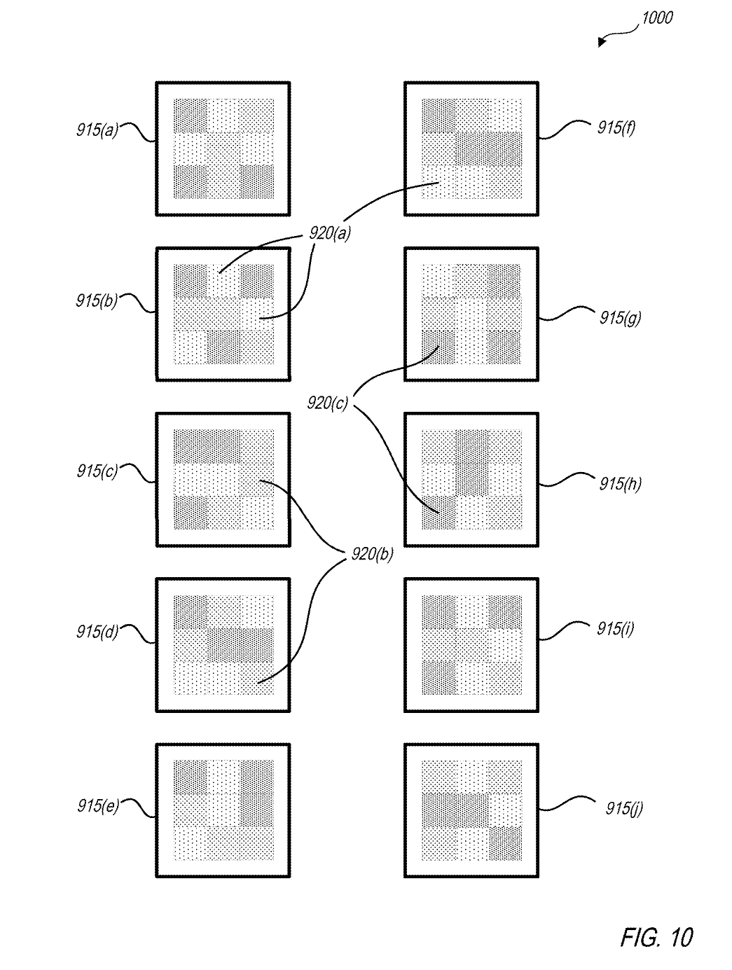

FIG. 10 schematically illustrates a composite lighting system 1000. System 1000 includes a set of luminaires 915, designated as luminaires 915(a) through 915(j). Luminaires 915 may be examples of luminaires 901, 902 (FIGS. 9A, 9B) and/or other luminaires or composite light sources as described herein. Each luminaire 915 includes multiple illumination panels 920. Like FIGS. 9A and 9B, luminaires 915 feature a 3 by 3 grid of square illumination panels, but the principles herein extend to luminaires having fewer or more illumination panels, luminaires with non-square illumination panels, etc. In certain embodiments, all illumination panels 920 emit light of the same chromaticity as one another, however this is not necessarily the case in all embodiments. Each illumination panel 920 emits light at one of at least three discrete levels of luminous intensity; for example, in FIG. 10, illumination panels 920 emitting a highest level of luminous intensity are designated as 920(a), illumination panels 920 emitting an intermediate level of luminous intensity are designated as 920(b) and illumination panels 920 emitting a lowest level of luminous intensity are designated as 920(c). Each luminaire 915 in FIG. 10 provides a same net lumen output as is provided by each other luminaire of the set. For example, in FIG. 10, each luminaire 915 has three illumination panels designated as 920(a), three illumination panels designated as 920(b) and three illumination panels designated as 920(c).

By providing multiple luminaires that provide the same net lumen output as one another, but providing the net lumen output using illumination panels with differing luminous intensities, system 1000 provides uniform area lighting from luminaires 915 that are somewhat interesting to look at. That is, system 1000 provides a pseudo-random collection of illumination panels 920(a), 920(b) and 920(c) such that distracting patterns are not present. The lack of distracting patterns is provided by observance of certain rules in the arrangement of luminous intensity levels within each luminaire 915, and from one luminaire 915 to the next. The rules listed in Table 3 below may be used to prevent the presentation of distracting patterns in composite lighting systems.

TABLE 3
Rules for avoiding distracting patterns
in composite lighting systems

| Rule | Within | Across | |
|---|---|---|---|
| No. | Luminaire | Luminaires | Criteria |
| 1 | X | | No three illumination panels of same |
| | | | luminous intensity in a row |
| 2 | X | | No three illumination panels of same |
| | | | luminous intensity along a diagonal |
| 3 | X | | No three illumination panels of same |
| | | | luminous intensity in an L shape at |
| | | | outside corner of a luminaire |
| 4 | X | | No three illumination panels of same |
| | | | luminous intensity in an L shape |
| | | | anywhere in a luminaire |
| 5 | | X | No two adjacent luminaires with same |
| | | | luminous intensity arrangements of |
| | | | illumination panels, in same orientation |
| 6 | | X | No two adjacent luminaires with same |
| | | | luminous intensity arrangements of |
| | | | illumination panels, in differing |
| | | | orientation |
| 7 | | X | No two luminaires anywhere with same |
| | | | luminous intensity arrangements of |
| | | | illumination panels, in same orientation |
| 8 | | X | No two luminaires anywhere with same |
| | | | luminous intensity arrangements of |
| | | | illumination panels, in differing |
| | | | orientation |

In Table 3, an X in the second or third column denotes whether the rule applies to illumination panels within a luminaire, or patterns formed by illumination pattern arrangements in entire luminaires, across a system. Also, the rules numbered 1 and 4 are considered the most important (but not mandatory), while rules 2, 3, 4, 6, 7, and 8 are considered more optional.

Composite lighting system 1000 obeys rules 1, 2, 3, 4, 5, 6, and 7, but not rule 8, shown in Table 3. For example, in system 1000, no luminaire 915 has three illumination panels of same luminous intensity in a row, along a diagonal or in an L shape (rules 1, 2, 3 and 4). All of rules 1, 2 and 3 can be expressed by saying that for any selected one of the illumination panels, no more than one illumination panel adjacent to the selected one emits light of the same luminous intensity as the selected one. Also, no luminaires having arrangements of illumination panels having the same luminous intensity exist; not only are there no adjacent luminaires having the same luminous intensity arrangements of illumination panels in the same orientation adjacent to one another (rule 5), there are also no adjacent luminaires having the same luminous intensity arrangements of illumination panels, but in a different orientation (rule 6). Also, no luminaires having the same luminous intensity arrangements of illumination panels, in the same orientation, exist anywhere in the system (rule 7).

Luminaire 915(i) has the same luminous intensity arrangement of illumination panels, but rotated 90 degrees clockwise, as luminaire 915(a), and luminaire 915(e) has the same luminous intensity arrangement of illumination panels, but rotated 90 degrees clockwise, as luminaire 915(c), violating rule 8. Yet, a viewer would be unlikely to notice these similarities unless they were pointed out, thus they are not readily perceived as distracting patterns.

There are several reasons for allowing rules 2, 3, 4, 6, 7 and 8 in Table 3 to be considered optional. One reason for allowing some of the above rules to be optional is to allow a certain degree of flexibility and economy of scale for manufacturing and installation of the systems disclosed herein. Also, in large installations there will be numerous enough luminaires that some degree of duplication becomes inevitable. Yet another reason is that certain luminaires (e.g., luminaire 901, FIG. 9A) may be configured to select one of a set of predetermined patterns, or a random pattern (that obeys at least rule 1, and optionally rules 2, 3 and/or 4) every time the luminaire is switched on. Yet the luminaires may make such selections without regard to what other luminaires are doing, because they are not centrally controlled, so compliance with rules 5 through 8 is not assured, but a user of a luminaire 901 may be able to force reassignment of luminous intensity patterns in any case that an existing pattern is found unsuitable (due to non-compliance with the rules of Table 3, or for any other reason).

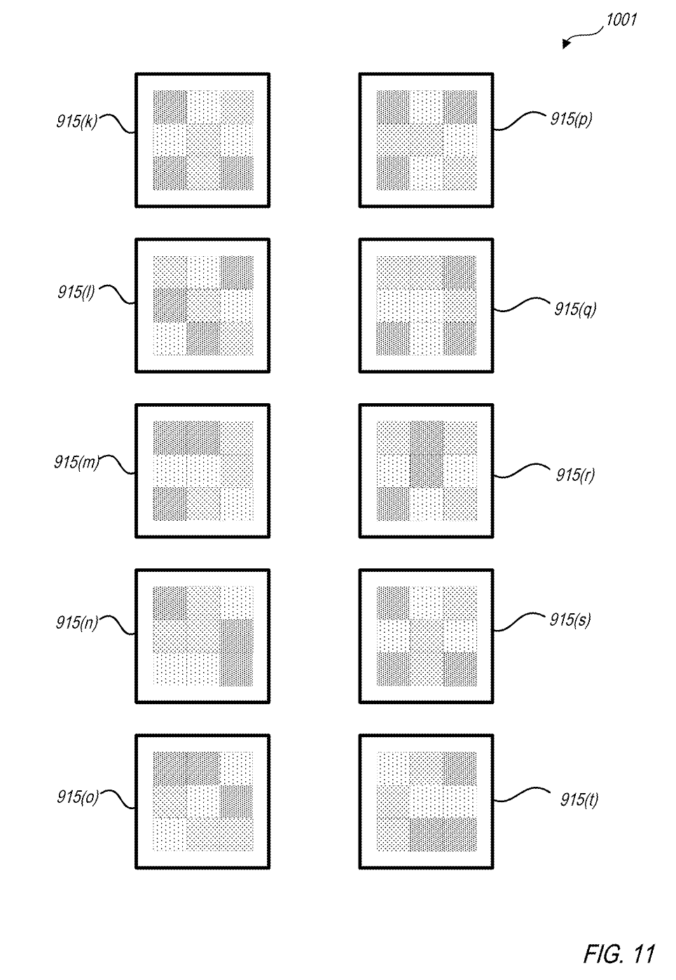

To further demonstrate why certain of the rules in Table 3 are optional, FIG. 11 schematically illustrates a composite lighting system 1001 that includes luminaires 915(k) through 915(t). Once again, luminaires 915 may be examples of luminaires 901, 902 (FIGS. 9A, 9B) and/or other luminaires or composite light sources as described herein. An observer of lighting system 1001 might consider its arrangements and patterns of luminous intensities as random as those shown in lighting system 1000, FIG. 10. Yet, lighting system 1001 breaks all of rules 2, 3, 6, 7, and 8 of Table 3. Luminaires 915(l) and 915(o) each have three illumination panels of the same luminous intensity along a diagonal, breaking rule 2. Luminaires 915(n) and 915(q) each have three illumination panels in an L shaped arrangement, breaking rule 3. Luminaires 915(k) and 915(p) are adjacent, and have the same arrangements of illumination panels, in differing orientations, breaking rules 6 and 8. Luminaires 915(k) and 915(s) have the same arrangement of illumination panels, in the same orientation, breaking rule 7.

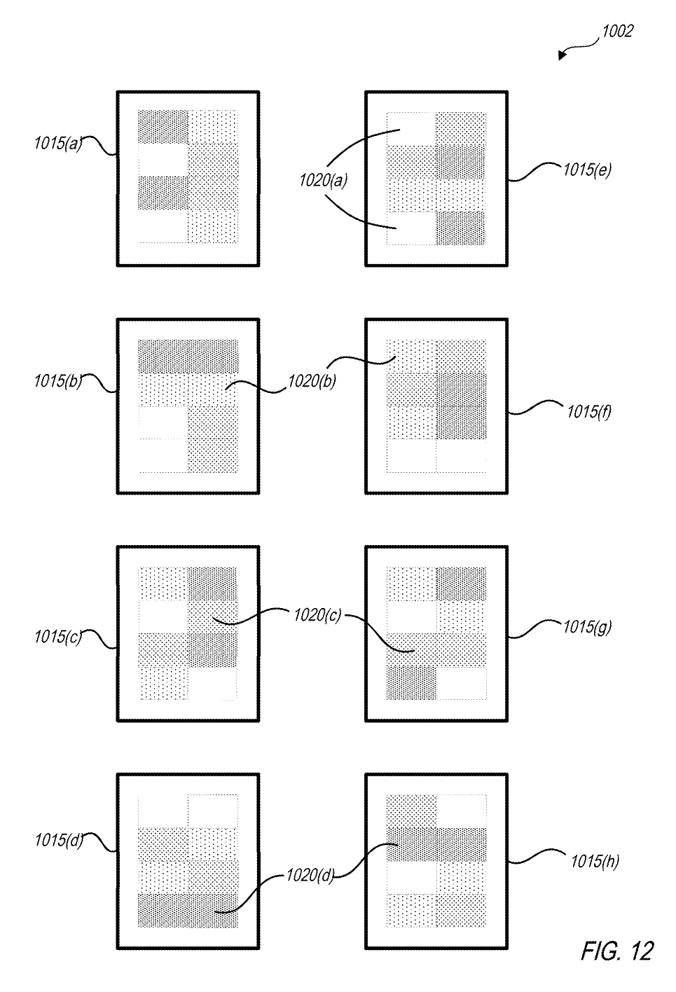

FIG. 12 schematically illustrates a composite lighting system 1002 that includes a set of luminaires 1015(a) through 1015(g). Luminaires 1015 may be examples of luminaires 901, 902 (FIGS. 9A, 9B) and/or other luminaires or composite light sources as described herein. System 1002 demonstrates a number of further possibilities for composite lighting systems as compared with lighting systems 1000, 1001 and others herein. Each of luminaires 1015(a) through 1015(g) includes eight illumination panels 1020 arranged in a grid of 2 by 4 panels, each luminaire 1015 having two each of illumination panels 1020(a), 1020(b), 1020(c) and 1020(d). Thus, each luminaire 1015 provides a same net lumen output as is provided by each other luminaire of the set. Also, illumination panels 1020 are not square, but are rectangular, thus illumination panels 1020 may be arranged in rectilinear grids, as shown in FIG. 12. Arrangements of luminous intensity of illumination panels 1020, both within and across luminaires 1015 obey all of rules 1 through 8 of Table 3.

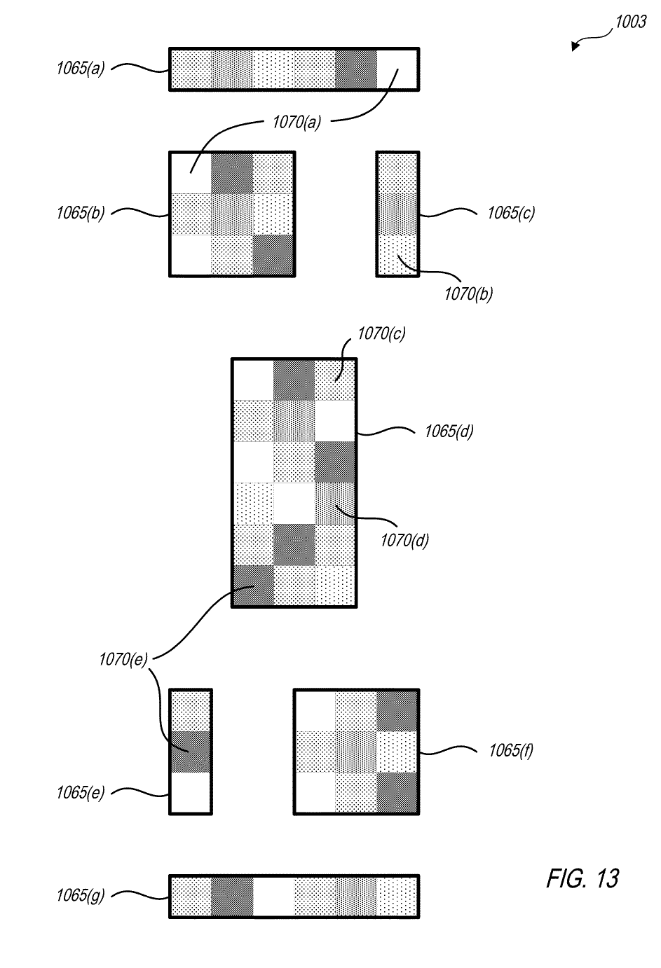

FIG. 13 schematically illustrates a composite lighting system 1003 that includes a set of luminaires 1065(a) through 1065(g). Luminaires 1065 may be examples of luminaires 901, 902 (FIGS. 9A, 9B) and/or other luminaires or composite light sources as described herein. System 1003 demonstrates a number of further possibilities for composite lighting systems as compared with lighting systems 1000, 1001, 1002 and others herein. Each of luminaires 1065(a) through 1065(g) includes several illumination panels 1070 arranged in rectilinear arrays, each luminaire 1065 having from three to eighteen of illumination panels 1070(a), 1070(b), 1070(c), 1070(d) and 1070(e). Illumination panels 1070(a), 1070(b), 1070(c), 1070(d) and 1070(e) are chosen and arrange in luminaires 1065 to obey all of rules 1 through 8 of Table 3, and with equal numbers of the brightest (1070(a), 1070(b)) and dimmest (1070(d), 1070(e)) illumination panels. Thus, each luminaire 1065 provides a same net lumen output per unit area of the layout (e.g., the light-emitting area of the illumination panels 1070 of each luminaire 1065), as is provided by each other luminaire of the set. However, luminaires 1065(c) and (e) include only three illumination panels 1070, luminaires 1065(a) and 1065(g) include six illumination panels 1070, luminaires 1065(b) and 1065(f) include nine illumination panels 1070, while luminaire 1065(d) includes eighteen illumination panels 1070. Therefore luminaires 1065 will have differing net lumen outputs per luminaire, although the net lumen output per unit area of each luminaire's layout will remain constant.

Thus, while lighting systems 1000, 1001, 1002 and others explicitly provided luminaires of consistent size and therefore constant net lumen output per luminaire (within each system), lighting system 1003 extends the concept by providing differently sized and shaped luminaires. The luminaires of lighting system 1003 provide differing net lumen output per luminaire, but in a manner consistent with the size of each luminaire, to provide a similar overall level of area lighting, and to promote visual interest in the luminaires themselves and in the system level design.

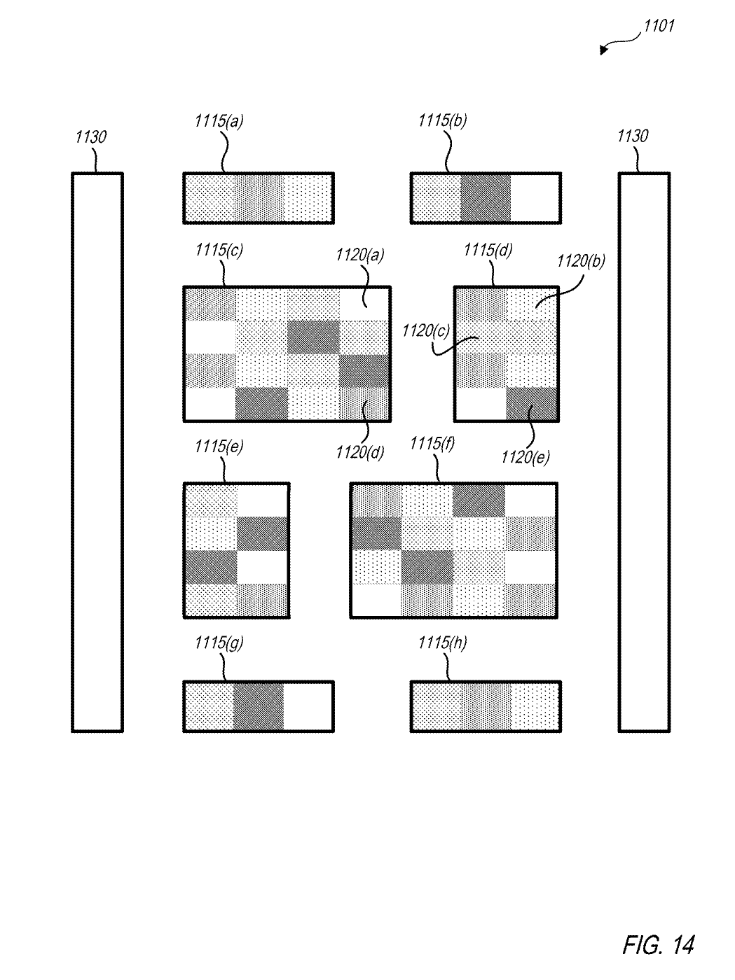

FIG. 14 schematically illustrates a composite lighting system 1101 that includes a set of luminaires 1115(a) through 1115(h) and two luminaires 1130. Luminaires 1115 may be examples of luminaires 901, 902 (FIGS. 9A, 9B) and/or other luminaires or composite light sources as described herein. Each of luminaires 1115(a) through 1115(h) includes anywhere from three to twelve illumination panels 1120 arranged in rectilinear grids of various sizes and shapes. Representative illumination panels that display highest luminous intensity are designated 1120(a); representative illumination panels that display lowest luminous intensity are designated 1120(e); certain representative illumination panels that display intermediate luminous intensities are designated 1120(b), 1120(c) and 1120(d). These designations are made irrespective of shape and size of the illumination panels. Each luminaire 1115 has three or more illumination panels selected from illumination panels 1120(a), 1120(b), 1120(c), 1120(d) and 1120(e).

Composite lighting system 1101 is similar to lighting system 1003 in that numbers of illumination panels 1120(a) through 1120(e) in each luminaire 1115 are coordinated such that each luminaire 1115 provides a same net lumen output per unit area of the luminaire layout as is provided by each other luminaire of the set. Thus, like lighting system 1003, luminaires 1115 of lighting system 1101 provide differing net lumen output per luminaire, but in a manner consistent with the size of each luminaire, to provide a similar overall level of area lighting, and to promote visual interest in the luminaires themselves and in the system level design.

Composite lighting system 1101 further includes optional luminaires 1130, which may be thought of as accent luminaires. One or more luminaires 1130 may provide light of any chromaticity or luminous intensity, as visual or purpose-specific complements to luminaires 1115. For example, luminaires 1130 might feature a signature corporate color, might be a spotlight or a so-called “wall wash” luminaire designed to illuminate an adjacent wall, and the like.

To implement composite light sources such as described above, with multiple illumination panels per luminaire, it is advantageous to provide a “clean” look wherein adjacent illumination panels closely adjoin one another across a common output plane. In embodiments, both the illumination panels and supporting structure thereof provide a flush surface at the output plane. Yet, each illumination panel should provide uniform illumination over its surface, and light from one illumination panel should not notably affect the illumination from an adjacent illumination panel. One potential way that light from one illumination panel can undesirably affect the illumination of an adjacent illumination panel is when a luminaire has a common optical lens or cover across a light emitting surface; a certain amount of light from one illumination panel can scatter or be Fresnel reflected into the adjacent illumination panel. This can be avoided by providing illumination panels that each have their own light emitters and output surfaces, with opaque materials extending through the output surfaces to the common output plane.

Mechanical features of composite light sources are now disclosed. In many embodiments, the following mechanical features provide illumination panels that are closely adjacent to one another, yet feature chromaticities and/or luminous intensities that are independent of one another. However, in other embodiments, composite light sources utilizing the mechanical features disclosed herein provide explicit optical mixing between adjacent illumination panels, and/or provide uniform light of a single chromaticity (usually, but not limited to, white) across all illumination panels.

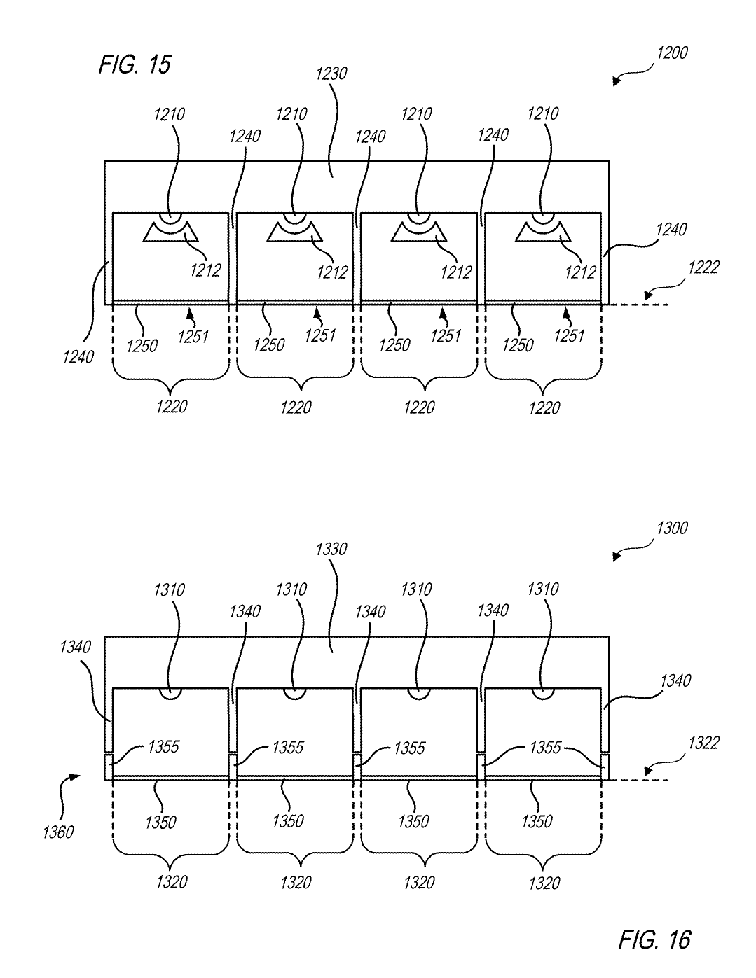

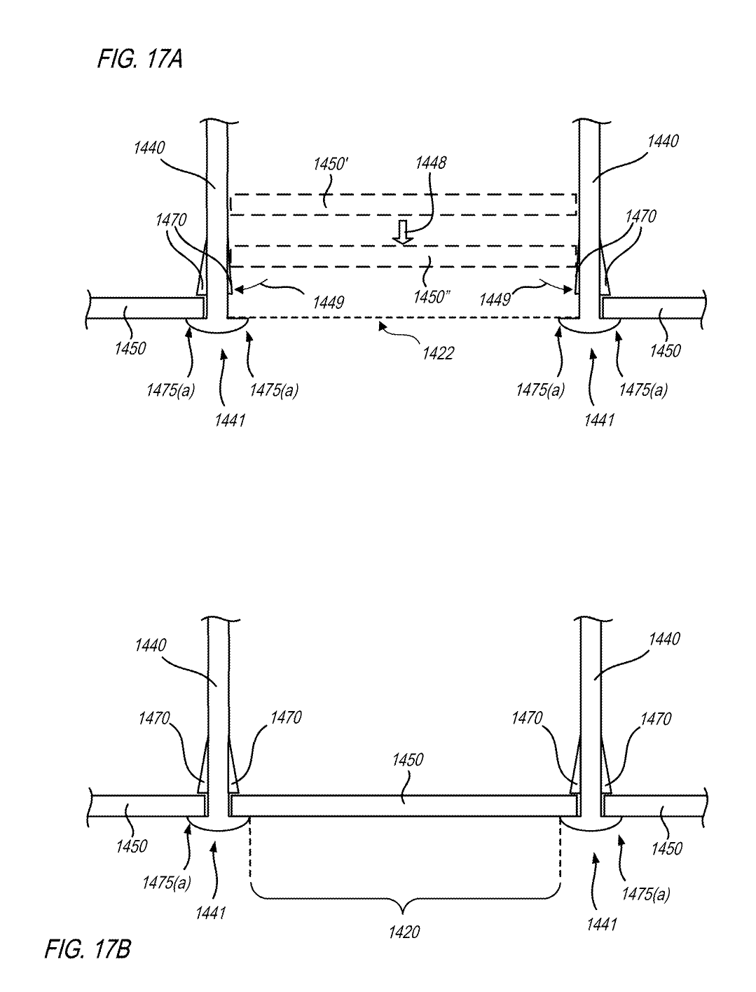

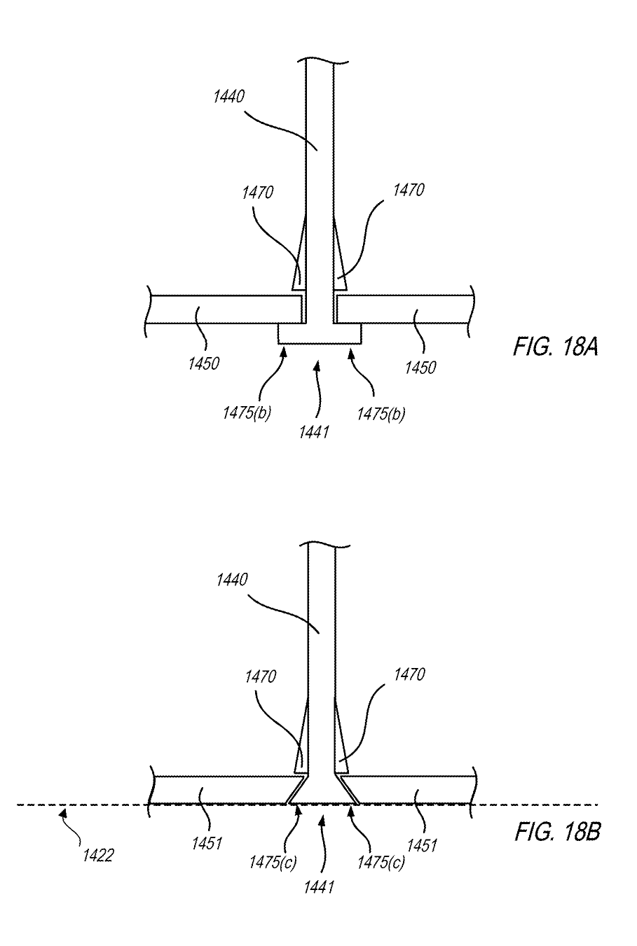

FIG. 15 is a schematic cross-sectional diagram illustrating features of a luminaire 1200. Luminaire 1200 may be an example of luminaires 901, 902 (FIGS. 9A, 9B) and/or other luminaires or composite light sources as described herein. Luminaires 1200 include illumination panels 1220 that can emit light of differing luminous intensities. Each illumination panel 1220 includes a light emitter 1210, and an output lens 1250. As discussed above, light emitters can be any type of light emitting devices, and also can be multiple or composite devices, such as arrays of LEDs. In embodiments, illumination panels 1220 may also include optional optics 1212 for shaping light from light emitters 1210. Each output lens 1250 has a planar outward surface 1251; all of the planar outward surfaces 125 are arranged along a common output plane 1222, as shown. A designation of a “common output plane” herein does not exclude deviations from an exact plane due to manufacturing imprecision or texturing of planar outward surface 1251 on the order of 0.125 inch or less. For example, in embodiments, a matte texturing is provided on planar outward surface 1251. A housing 1230 provides mechanical support for each illumination panel 1220. Housing 1230 includes baffles 1240 that optically isolate illumination panels 1220 from each other. Herein, “baffles” are typically either formed as part of, or added to, a housing structure to optically separate light emitted by light emitters starting at the light emitters themselves. Baffles 1240 are thus formed of a substantially opaque material. Baffles 1240 may also be advantageously of high reflectance, for high illumination efficiency, that is, so that light striking baffles 1240 reflects and eventually exits through output lens 1250. Viewed in the orientation of FIG. 15, with light emitters 1210 above common output plane 1222, baffles 1240 extend downwardly at least to the common output plane. Outwardly facing ends 1441 of baffles 1240 (not labeled in FIG. 16; see FIGS. 17A-18B) that are visible to a viewer are advantageously at least 0.125 inches in smallest dimension so that visual separation of adjacent illumination panels 1220 is evident and crisp looking to the viewer. However, ends 1441 are advantageously less than about 0.4 inches so that the illumination panels 1220 are still perceived as dominant visual elements over ends 1441. Small protrusions and recesses of baffles 1240 with respect to planar output surfaces 1251 of output lenses 1250 (e.g., less than about 0.125 inch, and/or the thickness of output lenses 1250) are considered immaterial to baffles 1240 being considered flush with common output plane 1222.

Certain embodiments of composite lighting systems similar to luminaire 1200 provide an output lens and divider assembly that may be added to an existing luminaire that may, but does not necessarily, include a baffle structure. Herein, “dividers” at least optically separate output lenses where light is eventually emitted from a luminaire. Thus, certain structures may be baffles, dividers, or both. Also, the term “isolating structure” in the description that follows may mean a baffle, a divider, or both.

FIG. 16 is a schematic cross-sectional diagram illustrating features of a composite light source 1300 that includes an output lens and divider assembly 1360. Luminaire 1300 includes a housing 1330 and baffles 1340 separating light emitters 1310. Divider assembly 1360 provides dividers 1355 and output lenses 1350 arranged along a common output plane 1322, as shown. Dividers 1355 maintain the optical isolation provided by baffles 1340 through output plane 1322, such that the resulting illumination panels 1320 are optically isolated from one another. Divider assembly 1360 may couple with housing 1330 by conventional means such as with fasteners, latches, clasps, clamps, press fit attachments or a hinge on one side of housing 1330, with a latch, fastener or the like on the other side of housing 1330. When luminaire 1200 includes baffles 1340, features of dividers 1355 that directly oppose baffles 1340 may be shaped so as to provide continuous opacity from baffles 1340 to dividers 1355, to ensure complete optical isolation of adjacent illumination panels 1320.

Use of divider assembly 1360 may be advantageous in several ways. For example, base luminaire assemblies that include housing 1330 can be manufactured in large quantities to maximize economies of scale, and light emitters 1340 and/or divider assemblies 1360 can be fabricated and added later in response to customer orders, to customize appearance. Also, divider assembly 1360 advantageously allows access behind common output plane 1322, to facilitate assembly of output lenses that snap into place (see FIGS. 17A, 17B). Another manufacturing modality that may be facilitated by separating manufacture of divider assembly 1360 from manufacture of housing 1330 is integrated co-molding of output lenses 1350 with dividers 1355 to form divider assemblies 1360.

FIGS. 17A and 17B are schematic cutaway diagrams illustrating manufacturing related features of a composite light source that provides output lenses and baffles or dividers, such as shown in FIGS. 15 and 16. In FIGS. 17A and 17B, isolating structure 1440 includes snap features 1470 that may be spring loaded or gravity operated mechanisms, or simply ridges that, in cooperation with isolating structure 1440, are deformable so as to allow an output lens to pass by easily in one direction and thereafter be retained. In the embodiment shown in FIG. 17A, portions of installed output lenses 1450 are shown engaged with isolating structure 1440 and snap features 1470. Another output lens being installed is designated in alternate positions in FIG. 17A as 1450′ and 1450″. As output lens 1450″, moving in the direction of an arrow 144, comes into contact with spring loaded snap features 1470, the snap features deflect in the directions of respective arrows 1449, an shown, allowing output lens 1450 to pass by. When output lens 1450 is fully in place as part of an illumination panel 1420 (e.g., with an output surface thereof aligned with a desired common output plane 1422, shown in FIG. 17A), flanges 1475(a) on the ends of isolating structure 1440 constrain output lens 1450 in a downward direction, and snap features 1470 snap into place to constrain output lens 1450 in an upward direction. Although FIGS. 17A and 17B illustrate snap features 1470 integrated with isolating structure 1440, it is contemplated that snap features 1470 could instead be integrated with dividers (e.g., dividers 1355, FIG. 16). Also, snap features could be designed to accept and retain output lenses installed from the facing side of a luminaire. That is, the output lens would be moved into place from beyond common output plane 1422 toward isolating structure 1440 and would snap into place when the output surface moves past the snap feature to the common output plane 1422.

FIGS. 18A and 18B are schematic cutaway diagrams, each illustrating manufacturing related features of a portion of a composite light source that provides output lenses and isolating structure, such as baffles and/or dividers, such as shown in FIGS. 15 and 16. In FIGS. 18A and 18B, isolating structure 1440 includes snap features 1470 that function identically as the same-named item in FIGS. 16A, 16B. In the embodiment shown in FIG. 18A, portions of installed output lenses 1450 are shown engaged with flanges 1475(b) of isolating structure 1440, and snap features 1470. Flanges 1475(b) have a square profile as opposed to the rounded profile of flanges 1475(a) shown in FIGS. 17A, 17B. Although FIGS. 17A and 18A illustrate flanges 1475(a) and 1475(b) respectively integrated with isolating structure 1440, it is contemplated that other flange shapes could be integrated with baffles or dividers. In the embodiment shown in FIG. 18B, portions of installed output lenses 1451 are shown engaged with flanges 1475(c) of isolating structure 1440, and snap features 1470. Output lenses 1451 feature beveled edges that rest against beveled flanges 1475(c) such that output lenses 1451 and a lower surface of flanges 1475(c) can form a completely flush surface at output plane 1422, as shown. Similar to the case of luminaire 1200, FIG. 15, protrusions and recesses of isolating structure 1440 and flanges 1475(c) with respect to the output surfaces of output lenses 1451 (e.g., less than about 0.125 inch, and/or about the thickness of output lenses 1451) are considered immaterial to isolating structure 1440 being considered flush with common output plane 1422.

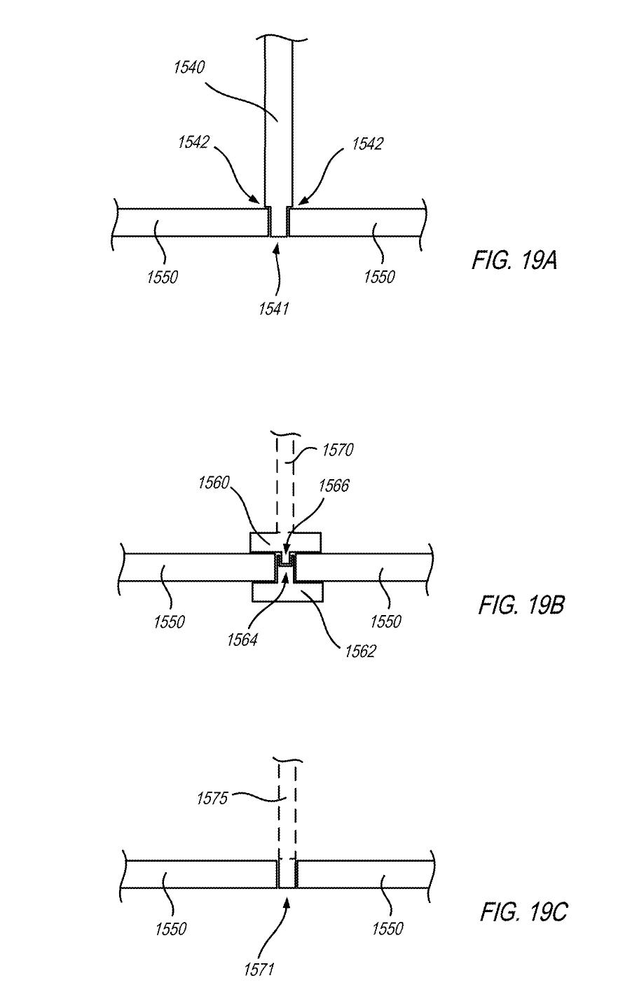

FIGS. 19A, 19B and 19C are schematic cutaway diagrams, each illustrating manufacturing related features of a portion of a composite light source that provides output lenses and isolating structure, such as baffles and/or dividers, such as shown in FIGS. 15 and 16. In FIG. 19A, end 1541 of isolating structure 1540 defines notches 1542, within which output lenses 1550 couple. Output lenses 1550 may be co-molded, bonded, glued or press-fit into place with isolating structure 1540.

In FIG. 19B, output lenses 1550 are secured in place within a two piece divider structure that includes an upper member 1560 and a lower member 1562. In certain embodiments, members 1560 and 1562 include mating features 1564 and 1566 to lock upper and lower members 1560 and 1562 together about sides of output lenses 1550. The illustrated shapes and mechanics of the illustrated mating features 1564 and 1566 are to be understood as illustrative only, other types of mating features will be readily conceived by those of skill in the art. In other embodiments, members 1560 and 1562 do not include mating features 1564 and 1566, but provide surfaces that can be bonded, glued or otherwise coupled about sides of output lenses 1550. Upper member 1560 may or may not extend further upwards into an optional structural support member 1570. When structural support member 1570 is not present, upper member 1560 and lower member 1562 act as local isolating structure, such that optical mixing may occur in a space above output lenses 1550. In such cases, lower member 1564 will act as a divider, providing a clean look from underneath and separating the illumination panels associated with the two output lenses 1550, but a clear separation of the chromaticity, luminous intensity and/or uniformity of the light being provided to the two illumination panels may not be possible. Therefore, the arrangement illustrated in FIG. 19B is considered especially advantageous for embodiments in which at least two adjacent illumination panels will provide light of similar chromaticity and luminous intensity. When structural support member 1570 is present, upper member 1560 and support member 1570 will act as isolating structure sufficient to prevent optical mixing in the space above output lenses 1550 such that the adjacent, corresponding illumination panels can operate independently in terms of chromaticity and luminous intensity.

In FIG. 19C, output lenses 1550 are secured in place by co-molding, bonding or gluing to at least a divider 1571, which may or may not extend further upwards into an optional structural support member 1575. Effects of the presence or absence of optional structural support member 1575 are similar to those of structural support member 1570 discussed above.

The foregoing is provided for purposes of illustrating, explaining, and describing embodiments of the present invention. Further modifications and adaptations to these embodiments will be apparent to those skilled in the art and may be made without departing from the scope or spirit of the invention. Different arrangements of the components depicted in the drawings or described above, as well as components and steps not shown or described, are possible. Similarly, some features and subcombinations are useful and may be employed without reference to other features and subcombinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

What is claimed is:

1. A composite light source, comprising:
a plurality of at least eight illumination panels provided in a layout within the composite light source, wherein:
each of the illumination panels in the layout is adjacent to at least one other of the plurality of illumination panels;
all of the illumination panels emit light of substantially the same chromaticity as one another;
each illumination panel emits light characterized by one of at least first, second, and third discrete levels of luminous intensity;
at least one of the illumination panels emits light at the first level of luminous intensity;
at least one of the illumination panels emits light at the second level of luminous intensity; and
at least one of the illumination panels emits light at the third level of luminous intensity.

2. The composite light source of claim 1, wherein any selected one of the plurality of at least eight illumination panels emits light having luminous intensity at a same one of the first, second or third luminous intensity levels as no more than one illumination panel that is adjacent to the selected one of the plurality of at least eight illumination panels.

3. The composite light source of claim 2, wherein the selected one of the plurality of at least eight illumination panels emits light having luminous intensity at a same one of the first, second or third luminous intensity levels as no more than one illumination panel laterally or diagonally adjacent to the selected one of the plurality of at least eight illumination panels.

4. The composite light source of claim 1, wherein each of the plurality of at least eight illumination panels is rectilinear and the plurality of at least eight illumination panels forms a rectilinear array of at least two rows and at least two columns.

5. The composite light source of claim 4, wherein each of the plurality of at least eight illumination panels is square.

6. The composite light source of claim 5, wherein the plurality of at least eight illumination panels consists of nine of the illumination panels that form an array of three columns and three rows.

7. The composite light source of claim 1, wherein at least one of the plurality of at least eight illumination panels emits light at a fourth level of luminous intensity.

8. The composite light source of claim 1, wherein at least one of the plurality of at least eight illumination panels emits light at a fifth level of luminous intensity.

9. The composite light source of claim 1, wherein each of the levels of luminous intensity are at least ten percent different in luminous intensity relative to one another.

10. The composite light source of claim 1, wherein chromaticities of the light emitted by the illumination panels are within a five step MacAdam ellipse of one another.

11. The composite light source of claim 1,
wherein each one of the plurality of at least eight illumination panels comprises a corresponding output lens having a planar outward surface;
wherein the planar outward surfaces of the output lenses are arranged along a common output plane of the composite light source; and
wherein the output lenses are separated from one another by isolating structure that optically isolates the illumination panels from one another.

12. The composite light source of claim 11,
wherein each one of the plurality of at least eight illumination panels comprises a corresponding light emitter that provides the light for the one of the illumination panels and is disposed above the common output plane, and
wherein the composite light source further comprises a housing that provides mechanical support for the plurality of at least eight illumination panels, the housing comprising baffles as the isolating structure, the baffles extending downwardly at least to the common output plane.

13. The composite light source of claim 11,
wherein the isolating structure includes a snap feature that yields as one of the lenses moves toward the common output plane, and wherein the snap feature snaps into place to hold it in place, when an outward surface of the at least one of the lenses moves past the snap feature to the common output plane.

14. The composite light source of claim 11,
wherein the isolating structure is substantially flush with the outward surface of the at least one of the lenses at the common output plane.

15. The composite light source of claim 11,
wherein a divider assembly includes dividers and the output lenses as part of the isolating structure.

16. The composite light source of claim 15,
wherein the output lenses and dividers are bonded to form the divider assembly.

17. The composite light source of claim 1,
wherein each of the plurality of at least eight illumination panels emits light at its own respective level of luminous intensity, and
wherein the respective levels of luminous intensity emitted by each of the plurality of at least eight illumination panels does not change each time the composite light source is operated.

18. The composite light source of claim 1, wherein the composite light source includes a controller that assigns a level of luminous intensity emitted by each of the plurality of at least eight illumination panels.

19. The composite light source of claim 18, wherein the controller assigns the level of luminous intensity emitted by each of the plurality of at least eight illumination panels each time the composite light source is activated.

20. The composite light source of claim 18, wherein the controller reassigns the level of luminous intensity emitted by each of the plurality of at least eight illumination panels during operation of the composite light source.

21. The composite light source of claim 20, wherein the controller reassigns the level of luminous intensity emitted by each of the plurality of at least eight illumination panels during operation based on input received from a user.

22. The composite light source of claim 20, wherein the controller reassigns the level of luminous intensity emitted by each of the plurality of at least eight illumination panels during operation without receiving input from a user.

23. A composite lighting system, comprising:
a plurality of luminaires, each of the luminaires comprising at least three illumination panels provided in a layout;
wherein, across all luminaires of the composite lighting system:
all of the illumination panels emit light of substantially the same chromaticity as one another;
each illumination panel emits light characterized by one of at least first, second, and third discrete levels of luminous intensity;
at least one of the illumination panels emits light at the first level of luminous intensity;
at least one of the illumination panels emits light at the second level of luminous intensity;
at least one of the illumination panels emits light at the third level of luminous intensity; and
each of the plurality of luminaires has an identical layout of the illumination panels as each other luminaire of the plurality of luminaires, and provides a same net lumen output as is provided by each other luminaire of the plurality of luminaires.

24. The composite light source of claim 23, wherein, in each luminaire:
each of the at least three illumination panels in the layout is adjacent to at least one other of the at least three illumination panels in the luminaire;
any selected one of the at least three illumination panels in the luminaire emits light of the same luminous intensity as no more than one illumination panel adjacent to the selected one of the at least three illumination panels in the luminaire.

25. The composite light source of claim 23, wherein arrangements of the first, second, and third discrete levels of luminous intensity across the at least three illumination panels of each luminaire are different for at least two luminaires of the composite lighting system.

26. A composite lighting system, comprising:
a plurality of luminaires, each of the luminaires comprising at least three illumination panels provided in a layout;
wherein at least one of the luminaires of the composite lighting system has a layout that differs from a layout of at least one other of the luminaires of the composite lighting system;
wherein each of the plurality of luminaires provides a same net lumen output per unit area of the layout, as is provided by each other luminaire of the plurality of luminaires; and
wherein, across all luminaires of the composite lighting system:
all of the illumination panels emit light of substantially the same chromaticity as one another;
each illumination panel emits light characterized by one of at least first, second, and third discrete levels of luminous intensity;
at least one of the illumination panels emits light at the first level of luminous intensity;
at least one of the illumination panels emits light at the second level of luminous intensity; and
at least one of the illumination panels emits light at the third level of luminous intensity.
